(19) United States
(12) Patent Application Publication
(10) Pub. No.: US 2026/0073230 A1
(43) Pub. Date: Mar. 12, 2026

(54) Method and Apparatus for Generating Deep Ensemble Model for Image Classification, and Computer Device

(71) Applicant: SUZHOU UNIVERSITY OF TECHNOLOGY, Suzhou (CN)

(72) Inventors: Haitong Zhao, Suzhou (CN); Xiaoshuang Xing, Suzhou, Jiangsu (CN); Xiaolu Cheng, Suzhou (CN); Chao Su, Suzhou (CN); Can Tong, Suzhou (CN)

(21) Appl. No.: 19/394,908

(22) Filed: Nov. 20, 2025

Related U.S. Application Data
(63) Continuation of application No. PCT/CN2024/101506, filed on Jun. 26, 2024.

(30) Foreign Application Priority Data
Nov. 1, 2023 (CN) 202311436678.X

(51) Int. Cl. G06N 3/09; G06N 3/045; G06V 10/776; G06V 10/82

(52) U.S. Cl. CPC G06N 3/09; G06N 3/045; G06V 10/776; G06V 10/82

(57) ABSTRACT

Provided are a method and apparatus for generating a deep ensemble model for image classification, and a computer device. The method includes: randomly sampling, from a search space of classical convolutional neural network (CNN) models for image classification, a neural architecture of a first group of CNN models; collecting representative image samples based on a scenario of an image classification task, marking the collected image samples with classification labels, constructing a training dataset based on the marked image samples, and training the sampled first group of CNN models based on the training dataset and evaluating image classification performance thereof; generating a second group of CNN models based on a surrogate model and the trained first group of CNN models; and constructing a structure of a deep ensemble model for image classification based on the second group of CNN models and a multi-objective optimization strategy.

### CROSS REFERENCE TO RELATED APPLICATION

The present disclosure is a Continuation application of PCT Application No. PCT/CN2024/101506 filed on Jun. 26, 2024, which claims the priority of Chinese Patent Application No. 202311436678.X filed with the China National Intellectual Property Administration on Nov. 1, 2023 and entitled “METHOD AND APPARATUS FOR GENERATING DEEP ENSEMBLE MODEL, AND COMPUTER DEVICE”, which is incorporated herein by reference in its entirety.

### TECHNICAL FIELD

The present disclosure relates to the technical field of image classification, and in particular, to a method and apparatus for generating a deep ensemble model for image classification, and a computer device. The method, model, apparatus, and device of the present disclosure can be applied to image classification tasks in fields such as visual search, image tagging, content filtering, medical image analysis, security surveillance, and agricultural and environmental detection.

### BACKGROUND ART

With the development of artificial intelligence (AI) technology, the application domains of AI have become increasingly broad, while the cost requirements for machine learning and deep learning have become increasingly high. Deep learning and machine learning have achieved significant results in the field of image processing. However, some current deep learning models still face the problem of insufficient generalization capability on image processing tasks, leading to performance on real-world images that is far inferior to their performance on training datasets.

Typically, a deep ensemble model is an ensemble model composed of a plurality of heterogeneous neural networks (NNs). The neural architecture of the deep ensemble model is more complex than that of a single NN. Since the neural architecture is correlated with model performance, it is required to determine the neural architecture in deep learning. That is, the mode of each layer and the connection relationship between layers are required. Currently, deep ensemble models can be designed either manually or automatically.

However, manual design requires specialized expertise and extensive experience, and existing methods for automatically designing deep ensemble model architectures have the problems of low efficiency and poor diversity. Therefore, there is an urgent need for a method that can rapidly generate deep ensemble models to enhance the performance of deep ensemble learning models.

### SUMMARY OF THE INVENTION

In order to overcome the problems existing in the related art, the present disclosure provides a method and apparatus for generating a deep ensemble model for image classification, and a computer device.

According to a first aspect of embodiments of the present disclosure, provided is a method for generating a deep ensemble model for image classification, including: randomly sampling, from a search space of classical convolutional neural network (CNN) models for image classification, a neural architecture of a first group of CNN models; collecting representative image samples based on a scenario of an image classification task, marking the collected image samples with classification labels, and constructing a training dataset based on the marked image samples, where the image classification task includes at least one of visual search, image tagging, content filtering, medical image analysis, security surveillance, agricultural monitoring, and environmental detection; training the sampled first group of CNN models based on the training dataset and evaluating image classification accuracy rates of the sampled first group of CNN models; generating a second group of CNN models based on a surrogate model and the trained first group of CNN models; and constructing a structure of a deep ensemble model for image classification based on the second group of CNN models and a multi-objective optimization strategy, where the structure of the deep ensemble model includes a shared block.

Optionally, the generating a second group of CNN models based on a surrogate model and the trained first group of CNN models includes:
generating the second group of CNN models based on a single-objective differential evolution operation, the surrogate model, and the trained first group of CNN models.

Optionally, the generating the second group of CNN models based on a single-objective differential evolution operation, the surrogate model, and the trained first group of CNN models includes:
encoding and clustering the trained first group of CNN models, extracting centroids of clustering for constructing a first parent population, and training a performance comparator using the sampled first group of CNN models;
if a training stop criterion is not met, generating a first offspring population by the single-objective differential evolution operation, and combining the first parent population and the first offspring population into a new first parent population;
determining whether the performance comparator is used;
if the performance comparator is used, sorting the new first parent population using a merging and sorting approach of the surrogate model, and constructing a next-generation population by tournament selection; and if the training stop criterion is met, outputting a final-generation population, wherein the final-generation population is the second group of CNN models.

Optionally, after determining whether the performance comparator is used, the method further includes:
if the performance comparator is not used, decoding and training the CNN models in the first offspring population;
sorting the new first parent population by accuracy; and
training the performance comparator using the first offspring population,
wherein at intervals of T iterations, the CNN models of the new first parent population are trained using the training dataset, true accuracy rates of the CNN models of the new first parent population are tested using a validation dataset, candidate solutions are sorted according to the trained performance comparator, and a high-quality candidate solution is selected; incremental training is performed on the trained performance comparator using a neural architecture code of the CNN models of the new first parent population and corresponding sorted accuracy rates as training data; or in other cases, performance of the CNN models of the new first parent population is evaluated and sorted with respect to performance using the trained performance comparator.

Optionally, the encoding and clustering the trained first group of CNN models includes:
encoding each CNN model in the trained first group of CNN models and an error rate of image classification corresponding to each CNN model as a real vector, and clustering the encoded real vectors into a plurality of classes,
wherein the error rate is expressed as

$$minimize f ( x ) = 1 - \frac{1}{N} {\sum }_{{i}_{1} = 1}^{\vert G \vert} {\sum }_{s : {g}_{x} ( s ) = {i}_{1}} I ( {g}_{x} ( s ) = \hat{g} ( s ) ) ,$$

where, N represents a number of test samples; |G| represents a number of test sample types; i₁ represents a test sample i₁; x represents a solution of a test sample s; gₓ(s) represents a classification result of the solution x of the test sample s; ĝ(s) represents a real class of the test sample s; I(.) represents a discrimination function; and when gₓ(s)=ĝ(s), 1 is returned, or otherwise, 0 is returned.

Optionally, the search space of the CNN models includes four convolutional blocks and one pooling layer; a structure of each convolutional block is determined by hyperparameters of the convolutional block that include at least one of a convolutional unit type, a convolutional layer channel expansion factor, and a convolutional layer repeat count; and the method further includes:
encoding each CNN model as an integer array of a fixed length according to the hyperparameters of each convolutional block.

Optionally, the generating the second group of CNN models based on a single-objective differential evolution operation, the surrogate model, and the trained first group of CNN models includes:
altering each overall CNN model structure in the trained first group of CNN models based on a first mutation operator; or
altering a single convolutional block in each CNN model in the trained first group of CNN models based on a second mutation operator.

Optionally, the first mutation operator and the second mutation operator are different values of a target mutation operator which is expressed as:

$${\vec{v}}_{t}^{{j}_{1}} = \{ \begin{matrix}{\vec{y}}^{{r}^{1}} + F \cdot ( {\vec{y}}^{{r}^{2}} - {\vec{y}}^{{r}^{3}} ) , & rang ( 0 , 1 ) \leq r \\ {\vec{y}}^{{j}_{1}} + F \cdot \vec{d} , & others\end{matrix} ,$$

where, j₁ represents an index of a CNN model j₁ in a population;

$${{v}_{t}}^{{\to }^{{j}_{1}}}$$

represents a mutation intermediate obtained after mutation of the CNN model j₁ in the population at a generation t; \vec{y}^{h} represents the CNN model j₁ in the population; \vec{y}^{r}^{¹}, \vec{y}^{r}^{²}, and \vec{y}^{r}^{³} represent random neighbor CNN models randomly selected from a neighborhood of \vec{y}^{j}^{₁}; F represents a factor for controlling a range of a mutated CNN model; r represents a real number in [0, 1] randomly generated by a random number generator rand(0,1); \vec{d} represents a vector

$$\vec{d} = {\vec{y}}_{t - 1}^{best} - {\vec{y}}_{t - 2}^{best}$$

of a change direction of an optimal solution;

$${\vec{y}}_{t - 1}^{best} and {\vec{y}}_{t - 2}^{best}$$

correspond to optimal solutions of generations t−1 and t−2; and t represents a current iteration round.

Optionally, the generating the second group of CNN models based on a single-objective differential evolution operation, the surrogate model, and the trained first group of CNN models includes:
swapping an original CNN model and a convolutional block of the original CNN model based on a first crossover operator; or swapping a random bit of the original CNN model based on a second crossover operator,
wherein the first crossover operator is

$${u}_{{j}_{2}} = \{ \begin{matrix}{v}_{{j}_{2}} ; r and ( 0 , 1 ) \leq C R , {j}_{2} = 3 {r}_{i 2} , 3 {r}_{i 2} + 1 , or 3 {r}_{i 2} + 2 \\ {w}_{{j}_{2}} ; others\end{matrix} ,$$

where, rᵢ₂=randI(0,2),
rᵢ₂ represents an integer i₂ randomly generated by a random integer generator randI(0,2) within a range [0, 2]; CR represents a preset crossover probability factor; j₂ represents an index of a variable dimension j₂; uⱼ_{₂} represents a result of a first crossover operator j₂; vⱼ_{₂} represents a dimension j₂ of a mutated solution of the target mutation operator; and wⱼ_{₂} represents a dimension j₂ of an original candidate solution of the target mutation operator; and
the second crossover operator is

$${u}_{{j}_{3}} = \{ \begin{matrix}{v}_{j 3} ; r and ( 0 , 1 ) \leq CR \\ {w}_{j 3} ; others\end{matrix} ,$$

where, uⱼ_{₃} is represents a result of a second crossover operator j₃; vⱼ_{₃} represents a dimension j₃ of the mutated solution of the target mutation operator j₃; and vⱼ_{₃} represents a dimension j₃ of the original candidate solution of the target mutation operator.

Optionally, constructing a structure of a deep ensemble model for image classification based on the second group of CNN models and a multi-objective optimization strategy includes:
evaluating the second group of CNN models based on a first objective function and a second objective function, and constructing the deep ensemble model for image classification, wherein the first objective function is configured to determine the accuracy of the deep ensemble model, and the second objective function is configured to determine the diversity of the deep ensemble model;
wherein the first objective function is

$$acc ( x ) = \frac{1}{N} {\sum }_{{i}_{1} = 1}^{\vert G \vert} {\sum }_{s : gx ( s ) = {i}_{1}} I ( {g}_{x} ( s ) = \hat{g} ( s ) ) ,$$

where, N represents the number of test samples, |G| represents the number of test sample types, i₁ represents the test sample i₁, x represents the solution of the test sample s, gₓ(s) represents the classification result of the solution x of the test sample s, ĝ(s) represents the real class of the test sample s, I(.) represents the discrimination function, and when gₓ(s)=ĝ(s), 1 is returned, or otherwise, 0 is returned; and the second objective function is

$$d ( x ) = {\sum }_{{i}_{4} = 1}^{m} {\sum }_{{{j}_{4} = {i}_{4} + 1}^{}}^{m} ( \sqrt{{\sum }_{k = 1}^{d} {( {a}_{{i}_{4}}^{k} - {a}_{{j}_{4}}^{k} )}^{2}} + {\sum }_{p = 1}^{\vert G \vert} I ( g ( {a}_{{i}_{4}} , {s}_{p} ) = g ( {a}_{{j}_{4}} , {s}_{p} ) ) ) ,$$

where, aᵢ_{₄} represents an output of a head i₄ of the deep ensemble model,

$${a}_{{i}_{4}}^{k}$$

represents an architecture of the architecture of a k-thdimension of the head i₄,

$${a}_{{j}_{4}}^{k}$$

represents an architecture of the k-th dimension of the head j₄, g(aᵢ_{₄},sₚ) represents an output of aᵢ_{₄} on a p-th test sample sₚ, d represents a dimension of a code of a head,

$$\sqrt{{\sum }_{k = 1}^{d} {( {a}_{{i}_{4}}^{k} - {a}_{{j}_{4}}^{k} )}^{2}}$$

represents a Euclidean distance between the head i₄ and the head j₄, and

$${\sum }_{p = 1}^{\vert G \vert} I ( g ( {a}_{{i}_{4}} , {s}_{p} ) = g ( {a}_{{j}_{4}} , {s}_{p} ) )$$

represents a number of test samples with different classification results.

Optionally, the external archive stores non-dominated solutions meeting a preset objective function; if a first candidate solution of candidate solutions of the preset objective function meets that there are no other candidate solutions superior to the first candidate solution on two optimization objectives, namely the first objective function and the second objective function, the first candidate solution is the non-dominated solution; and the first candidate solution is any candidate solution;
wherein the preset objective function is −xⱼ_{₅} ∈W, j₅≠i₅, ∇xⱼ₅^{k}

$$\geq {x}_{{i}_{5}}^{k} ,$$

where, xⱼ_{₅} represents a candidate solution j₅, W represents a set of candidate solutions,

$${x}_{{i}_{5}}^{k}$$

represents the k-th dimension of a candidate solution i₅, namely i₅, and

$${x}_{{j}_{5}}^{k}$$

represents the k-th dimension of the candidate solution j₅, namely xⱼ_{₅}.

Optionally, the encoding and clustering the trained first group of CNN models includes:
encoding the trained first group of CNN models based on an integer array,
wherein each element of the integer array is an index of the trained first group of CNN models, a length of the array is m, a first element of the integer array represents an index of a CNN model contributing a shared layer, and a second element to an m-th element of the integer array represent indexes of CNN models constructing a head architecture.

In a second aspect, the present disclosure provides an apparatus for generating a deep ensemble model, including a sampling module, a dataset construction module, a training and evaluation module, a generation module, and a model construction module,
wherein the sampling module is configured to randomly sample, from a search space of classical convolutional neural network (CNN) models for image classification, a neural architecture of a first group of CNN models;
the dataset construction module is configured to collect representative image samples based on a scenario of an image classification task, mark the collected image samples with classification labels, and construct a training dataset based on the marked image samples, wherein the image classification task includes at least one of visual search, image tagging, content filtering, medical image analysis, security surveillance, agricultural monitoring, and environmental detection;
the training and evaluation module is configured to train the sampled first group of CNN models based on the training dataset and evaluate image classification performance of the sampled first group of CNN models;
the generation module is configured to generate a second group of CNN models based on a surrogate model and the trained first group of CNN models; and
the model construction module is configured to: randomly construct a second parent population based on the second group of CNN models; if a stop criterion is not met, perform a bi-objective differential evolution operation on the second group of CNN models to generate a second offspring population; evaluate the second offspring population, and combine the second offspring population and the second parent population into a new second parent population; select, from the new second parent population, non-dominated solutions to a current multi-objective optimization problem, wherein for any non-dominated solution, no any solution that is superior to the non-dominated solution on all optimization objectives is present in the new second parent population; update an external archive to save the non-dominated solutions; construct a next-generation population by tournament selection; if the stop criterion is met, decode a solution with the highest accuracy in the external archive; and output a constructed CNN ensemble model, wherein the CNN ensemble model is a deep ensemble model for image classification, and a structure of the deep ensemble model includes a shared block.

In a third aspect, the present disclosure provides a computer device, including a memory, a processor, and a computer program stored on the memory and runnable on the processor, wherein the processor, when executing the program, implements the method according to the first aspect of the present disclosure.

The technical solutions provided by the embodiments of the present disclosure may include the following beneficial effects:

In the embodiments of the present disclosure, firstly, the first group of CNN models is randomly sampled from the search space of the classical CNN models for image classification; then, the representative image samples are collected based on the scenario of the image classification task, the collected image samples are marked with the classification labels, and the training dataset is constructed based on the marked image samples, where the image classification task includes at least one of visual search, image tagging, content filtering, medical image analysis, security surveillance, agricultural monitoring, and environmental detection; subsequently, the sampled first group of CNN models is trained based on the training dataset, and evaluated; the second group of CNN models is then generated based on the surrogate model and the trained first group of CNN models; finally, the structure of the deep ensemble model for image classification is constructed based on the second group of CNN models and the multi-objective optimization strategy, where the structure of the deep ensemble model includes the shared block. In other words, a group of high-precision CNN models is first trained and generated at a first stage, and then the deep ensemble model at a second stage is constructed using the high-precision CNN models. The first stage is a single-objective optimization process, thus a convergence rate is relatively high. The second stage involves a combination with a small-scale search space, thus computing resources can be saved.

It should be understood that the above general description and the following detailed description are only exemplary and explanatory, and should not be construed as a limitation to the present disclosure.

### BRIEF DESCRIPTION OF THE DRAWINGS

The accompanying drawings incorporated into the specification and constituting part of the specification illustrate the embodiments of the present disclosure, and serve, together with the specification, to explain the principles of the present disclosure.

FIG. 1 is a flowchart of a method for generating a neural ensemble module illustrated according to one or more embodiments of the present disclosure;

FIG. 2 is a schematic structural diagram of a convolutional unit illustrated according to one or more embodiments of the present disclosure;

FIG. 3 is a schematic diagram of a code of a backbone architecture of a CNN model illustrated according to one or more embodiments of the present disclosure;

FIG. 4 is a flowchart of a method for generating a deep ensemble model illustrated according to one or more embodiments of the present disclosure;

FIG. 5 is a flowchart of a method for generating a deep ensemble model illustrated according to one or more embodiments of the present disclosure;

FIG. 6 is a schematic diagram of an execution logic of a method for generating a deep ensemble model illustrated according to one or more embodiments of the present disclosure;

FIG. 7 is a schematic diagram of a trend of an error rate illustrated according to one or more embodiments of the present disclosure;

FIG. 8 is a schematic diagram of comparison on an error rate and a search time illustrated according to one or more embodiments of the present disclosure;

FIG. 9 is a schematic diagram of comparison between error rates illustrated according to one or more embodiments of the present disclosure;

FIG. 10 is a schematic diagram showing an influence of a number of basic classifiers on a generalization capability illustrated according to one or more embodiments of the present disclosure;

FIG. 11 is a possible schematic structural diagram of an apparatus for generating a deep ensemble model according to one or more embodiments of the present disclosure; and

FIG. 12 is a diagram of a hardware structure of a computer device where an apparatus for generating a deep ensemble model according to one or more embodiments of the present disclosure is located.

### DETAILED DESCRIPTION OF THE INVENTION

The technical terms in the related art of the present disclosure are first introduced below.

### 1. Deep Ensemble Model

A deep ensemble model is a deep learning model composed of a plurality of heterogeneous neural networks. Each element of the deep ensemble model is called a basic model. The diversity of the basic models can ensure the robustness of the deep ensemble model. That is, when a type of data input to the deep ensemble model is different from that of training data, the deep ensemble model can maintain good performance.

The deep ensemble model has a better robust generalization capability than a neural network with a linear architecture. The neural structure of the deep ensemble model is more complex than that of a single neural network. Before the model is applied, an appropriate neural network needs to be designed, where the neural network includes a specific model of each layer and a connection relationship between layers.

### 2. CNN Model

A CNN model is a deep learning method and exhibits excellent performance in image processing. A lot of advanced image processing models are constructed based on the CNN model. Due to sharing of parameters of a convolution kernel and sparse connection between convolutional layers, the CNN model can process grid data at a low computational expense, such as time sequence data, images, and audios.

### 3. Generalization Capability

A generalization capability refers to the adaptability of a machine learning algorithm to fresh samples. A purpose of learning is to learn laws implicit behind data. For data outside a learning set that follows the same law, a trained network can still provide suitable outputs. This capability is referred to as the generalization capability.

### 4. Image Classification

Image classification represents a critical application scenario for a deep ensemble model, in which the model is required to correctly classify images based on diverse features such as point features, local features, regional features, and overall features contained within images. Image classification enables broad applications across multiple domains, such as data storage and processing, social media, digital healthcare, and agricultural environmental protection, and serves as a foundational technology for content filtering, disease diagnosis, defect monitoring, disaster monitoring, and the like.

Exemplary embodiments will be described in detail herein, and examples thereof are represented in the accompanying drawings. When the following descriptions relate to the accompanying drawings, unless otherwise stated, same numerals in different accompanying drawings represent same or similar elements. Implementations described in the following exemplary embodiments do not represent all implementations consistent with the present disclosure. On the contrary, the implementations are merely examples of apparatuses and methods that are described in detail in the appended claims and consistent with some aspects of the present disclosure.

The terms used in the present disclosure are merely to describe the specific embodiments, instead of limiting the present disclosure. The singular forms such as “a”, “the” and “this” used in the present disclosure and the appended claims are also intended to include the plural forms, unless otherwise clearly stated in the context. It should also be understood that the term “and/or” used herein refers to and includes any of one or more of the associated listed items or all possible combinations.

It should be understood that, although terms first, second, third, etc. may be used in the present disclosure to describe various kinds of information, such information shall not be limited to these terms. These terms are only used to distinguish information of a same type from each other. For example, without departing from the scope of the present disclosure, “first” information may be referred to as “second” information, and similarly, “second” information may also be referred to as “first” information. Depending on the context, the word “if” used herein can be interpreted as “when”, “while”, or “in response to determining”.

The embodiments of the present disclosure will be described in detail below.

For ease of description, a method for generating a neural ensemble module provided by embodiments of the present disclosure is named as DENE in the embodiments of the present disclosure.

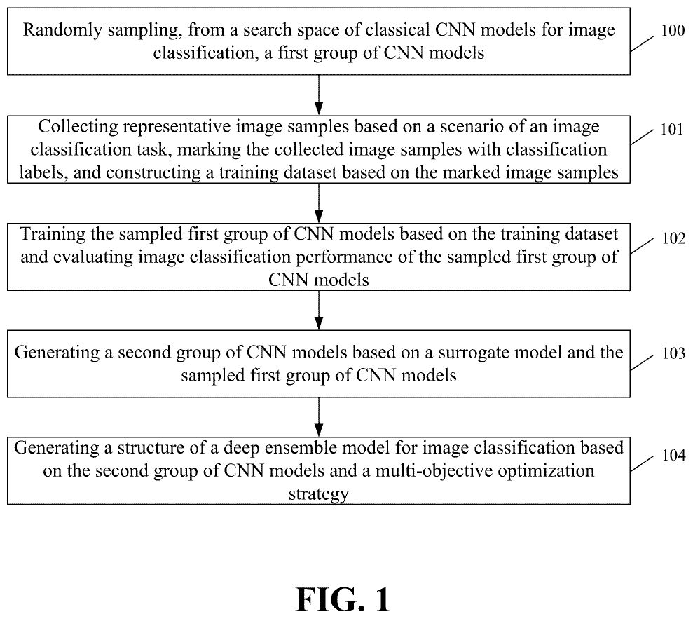

As shown in FIG. 1, FIG. 1 is a flowchart of a method for generating a neural ensemble module illustrated according to an exemplary embodiment of the present disclosure, including the following steps.

Step 100: randomly sampling, from a search space of classical CNN models for image classification, a first group of CNN models.

The search space of the CNN models includes four convolutional blocks and one pooling layer. A structure of each convolutional block is determined by hyperparameters of the convolutional block that include at least one of a convolutional unit type, a convolutional layer channel expansion factor, and a convolutional layer repeat count. Thus, each CNN model can be encoded as an integer array of a fixed length according to the hyperparameters of each convolutional block.

Exemplarily, in an embodiment of the present disclosure, the architecture of a candidate CNN model in the search space is a backbone architecture based on a wide residual network (WRN). The backbone architecture includes four convolutional blocks and one pooling layer. The four convolutional blocks are denoted by conv1, conv2, conv3, and conv4, respectively, where a filter of each convolutional block has a size of 3*3.

Table 1 is an exemplary table of a search space provided by an embodiment of the present disclosure.

TABLE 1

| | | Channel | | |
|---|---|---|---|---|
| | | Expansion | Number of | Repeat |
| Block | Operation | Coefficient | Channels | Count |
| Convolutional | 3*3 blocks | — | 16 | — |
| block 1 | | | | |
| Convolutional | (a) or (b) | k1 = {2, 4, 8, 10} | 16*k1 | {3, 6, 9} |
| block 2 | | | | |
| Convolutional | (a) or (b) | k2 = {2, 4, 8, 10} | 32*k2 | {3, 6, 9} |
| block 3 | | | | |
| Convolutional | (a) or (b) | k3 = {2, 4, 8, 10} | 64*k3 | {3, 6, 9} |
| block 4 | | | | |
| Pooling layer | Average | — | — | — |
| | pooling | | | |

In an embodiment of the present disclosure, the input data is processed according to the following sequence: conv1, conv2, conv3, conv4, and the pooling layer. The convolutional block 1 includes one convolutional layer and 16 channels. Each of the convolutional block 2, the convolutional block 3, and the convolutional block 4 may include a plurality of repeating convolutional units. The convolutional unit may be a convolutional unit of type a or a convolutional unit of type b, where the type a is a convolutional unit of a basic width, and the type b is a convolutional unit of an increased width.

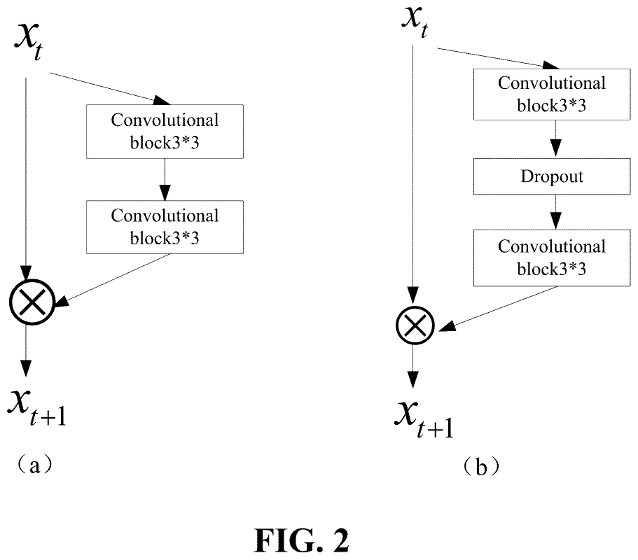

FIG. 2 is a schematic structural diagram of a convolutional unit provided by an embodiment of the present disclosure. As shown in FIG. 2, the convolutional unit (a) includes two convolutional layers, each having 3*3 convolutional blocks, and the convolutional unit (b) includes two convolutional layers, each having 3*3 convolutional blocks. There is a dropout operation included between the two convolutional layers.

It needs to be noted that, in the embodiments of the present disclosure, the backbone architecture of the candidate CNN model is encoded and represented using a fixed-length integer encoding approach. For example, a candidate CNN model may be represented by an integer array having a length of 9, where every 3 digits of the array represent the convolutional unit type, the convolutional layer channel expansion factor, and the convolutional layer repeat count of the second convolutional block to the fourth convolutional unit type.

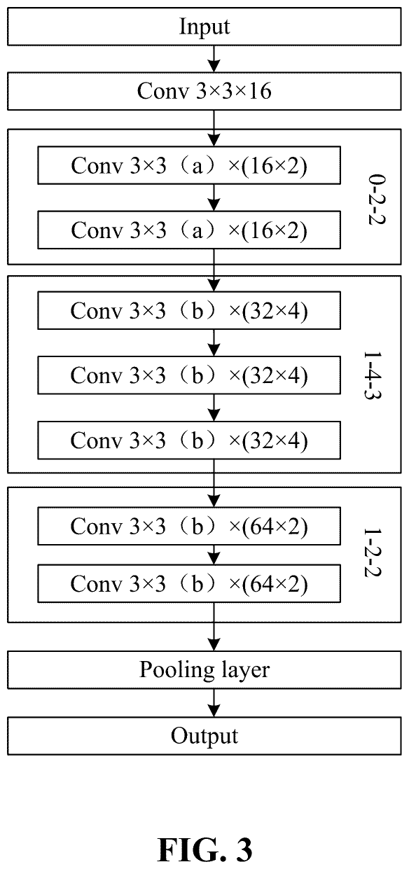

FIG. 3 is a schematic diagram of a code of a backbone architecture of a CNN model provided by an embodiment of the present disclosure. As shown in FIG. 3, conv2 uses the convolutional unit of the type a, with the convolutional layer channel expansion factor k1 of 2 and the convolutional layer repeat count of 2, and therefore, conv2 can be expressed as 0-2-2; conv3 uses the convolutional unit of the type b, with the convolutional layer channel expansion factor k1 of 4 and the convolutional layer repeat count of 3, and therefore, conv3 can be expressed as 1-4-3; conv4 uses the convolutional unit of the type b, with the convolutional layer channel expansion factor k1 of 2 and the convolutional layer repeat count of 2, and therefore, conv4 can be expressed as 1-2-2. Thus, the CNN model illustrated in FIG. 3 can be expressed as 0-2-2-1-4-3-1-2-2.

Step 101: collecting representative image samples based on a scenario of an image classification task, marking the collected image samples with classification labels, and constructing a training dataset based on the marked image samples.

Optionally, the image classification task includes at least one of visual search, image tagging, content filtering, medical image analysis, security surveillance, agricultural monitoring, and environmental detection.

Step 102: training the sampled first group of CNN models based on the training dataset and evaluating image classification performance of the sampled first group of CNN models.

Step 103: generating a second group of CNN models based on a surrogate model and the sampled first group of CNN models.

It needs to be noted that an embodiment of the present disclosure provides a performance ranking strategy based on a surrogate model that can predict performance ranking of candidate solutions. Without determining the accuracy of each solution, it can enable stable performance estimation based on the neural structure, which is independent of the quality of the candidate solutions. It is applied to a selection stage. The surrogate model is employed to estimate the performance of the candidate CNN model, rather than to train all the CNN models in the search space on a training set. Since the training is the most time-consuming process in the method, the generation efficiency of the neural ensemble can be improved.

Step 104: constructing a structure of a deep ensemble model for image classification based on the second group of CNN models and a multi-objective optimization strategy.

The structure of the deep ensemble model includes a shared block.

It needs to be noted that, in an embodiment of the present disclosure, the number of parameters of a CNN model ensemble is reduced by using a sampling layer sharing strategy. When a deep ensemble model is constructed, 3 convolutional blocks are fixed as a shared layer. For a CNN model ensemble with M heads, M different convolutional blocks and pooling layers are selected from the fourth convolutional blocks and the pooling layers of candidate CNN models.

The embodiments of the present disclosure provide the method for generating a deep ensemble model for image classification, including: firstly, randomly sampling, from the search space of the classical CNN models for image classification, first group of CNN models; then, collecting the representative image samples based on the scenario of the image classification task, marking the image samples with the classification labels, and constructing the training dataset based on the marked image samples, where the image classification task includes at least one of visual search, image tagging, content filtering, medical image analysis, security surveillance, agricultural monitoring, and environmental detection; subsequently, training the sampled first group of CNN models based on the training dataset and evaluating the sampled first group of CNN models; then, generating the second group of CNN models based on the surrogate model and the trained first group of CNN models; and finally, constructing the structure of the deep ensemble model for image classification based on the second group of CNN model and the multi-objective optimization strategy, where the structure of the deep ensemble model includes the shared block. In other words, a group of high-precision CNN models is first trained and generated at a first stage, and then the deep ensemble model at a second stage is constructed using the high-precision CNN models. The first stage is a single-objective optimization process, thus a convergence rate is relatively high. The second stage involves a combination with a small-scale search space, thus computing resources can be saved.

Optionally, the embodiments of the present disclosure provide a method for generating a deep ensemble model for image classification. In the above step 103, the second group of CNN models may be generated based on a single-objective differential evolution operation, the surrogate model, and the trained first group of CNN models. In the above step 104, the structure of the deep ensemble model for image classification may be constructed based on a bi-objective differential evolution operation, the second group of CNN models, and the multi-objective optimization strategy.

Specifically, step 103 may include the following steps.

Step 01: encoding and clustering the trained first group of CNN models, extracting centroids of clustering for constructing a first parent population, and training a performance comparator using the sampled first group of CNN models.

Specifically, each CNN model in the trained first group of CNN models and an error rate corresponding to each CNN model are encoded as a real vector, and the encoded real vectors are clustered into a plurality of classes.

The error rate may be determined based on Formula (1):

$$minimize f ( x ) = 1 - \frac{1}{N} {\sum }_{{i}_{1} = 1}^{\vert G \vert} {\sum }_{s : {g}_{x} ( s ) = {i}_{1}} I ( {g}_{x} ( s ) = \hat{g} ( s ) ) \qquad ( 1 )$$

where, N represents a number of test samples; |G| represents a number of test sample types; i₁ represents a test sample i₁; x represents a solution of a test sample s; gₓ(s) represents a classification result of the solution x of the test sample s; ĝ(s) represents a real class of the test samples; (.) represents a discrimination function; and when gₓ(s)=ĝ(s), 1 is returned, or otherwise, 0 is returned.

Step01: encoding the trained first group of CNN models based on an integer array.

Each element of the integer array is an index of the trained first group of CNN models, a length of the array is m, a first element of the integer array represents an index of a CNN model contributing a shared layer, and a second element to an m-th element of the integer array represent indexes of CNN models constructing a head architecture.

In other words, in an embodiment of the present disclosure, with the adoption of a data-driven CNN model initialization strategy based on clustering, a plurality of CNN models are randomly sampled first, then the plurality of CNN models are trained on a training set and tested on a validation set, then the CNN models and error rates corresponding to the CNN models are encoded as real vectors, the code is divided into a plurality of classes using a clustering method, and each cluster centroid constitutes an initial CNN model for next differential evolution operation.

Step 02: if a training stop criterion is not met, generating a first offspring population by the single-objective differential evolution operation, and combining the first parent population and the first offspring population into a new first parent population.

Step 03: determining whether the performance comparator is used.

The performance comparator is provided by the surrogate model.

Exemplarily, a light gradient boosting machine (GBM) may be selected as the surrogate model, where the light GBM is an efficient algorithm framework based on a gradient boosting decision tree (GBDT), and thus exhibits high training speed, low memory consumption, and high accuracy.

Exemplarily, whether the current iteration meets a preset fixed number of iterations may be determined so as to determine whether the performance comparator is used.

It needs to be noted that, if the performance comparator is used, the following step 04a is performed, and if the performance comparator is not used, the following step 04b is performed and the above step 03 is repeated.

Step 04a: if the performance comparator is used, sorting the new first parent population using a merging and sorting approach of the surrogate model, and constructing a next-generation population by tournament selection.

It needs to be noted that, based on the surrogate model and using the merging and sorting approach, a sorting approach with time complexity O(n log₂n) and space complexity O(n) may be obtained, which is stable.

Step 04b: if the performance comparator is not used, decoding and training the CNN models in the first offspring population; sorting the new first parent population by accuracy; and training the performance comparator using the first offspring population.

At intervals of T iterations, the CNN models of the new first parent population are not evaluated and sorted with respect to performance using the trained performance comparator; the CNN models of the new first parent population are trained using the training dataset, true accuracy rates of the CNN models of the new first parent population are tested using a validation dataset, candidate solutions are sorted according to the trained performance comparator, and a high-quality candidate solution is selected; and incremental training is performed on the trained performance comparator using a neural architecture code of the CNN models of the new first parent population and corresponding sorted accuracy rates as training data.

Alternately, in other cases, performances of the CNN models of the new first parent population are evaluated and sorted with respect to performance using the trained performance comparator.

It needs to be noted that the above-mentioned T iterations refer to iterations for optimizing the neural architecture of the CNN model using the evolution optimization approach described in the step 02.

Exemplarily, an input to the surrogate model is an integer string, one half of which is a code of a first CNN model and the other half of which is a code of a second CNN model, and a bool value is output, representing whether the first CNN model is better than the second CNN model.

For ease of description, the process of generating the first group of CNN models is called a CNN model initialization stage. In an embodiment of the present disclosure, the surrogate model is trained from the start using the candidate CNN models generated at the CNN model initialization stage, and is updated at intervals of certain generations, i.e., trained using a newly generated candidate scheme.

Step 05: if the training stop criterion is met, outputting a final-generation population, where the final-generation population is the second group of CNN models described above.

Specifically, the step 104 may include the following steps.

Step 11: randomly constructing a second parent population based on the second group of CNN models.

Step 12: if a stop criterion is not met, performing a bi-objective differential evolution operation on the second group of CNN models to generate a second offspring population; evaluating the second offspring population, and combining the second offspring population and the second parent population into a new second parent population; selecting, from the new second parent population, non-dominated solutions to a current multi-objective optimization problem, and updating an external archive to save the non-dominated solutions; and constructing a next-generation population by tournament selection.

Exemplarily, the stop criterion may be that the number of iterations reaches a set maximum number of iterations, the accuracy rate reaches a set highest accuracy rate, and so on, which will not be particularly defined in the embodiments of the present disclosure.

For any non-dominated solution, no any solution that is superior to the non-dominated solution on all optimization objectives is present in the new second parent population.

Step 13: if the stop criterion is met, decoding a solution with the highest accuracy in the external archive.

Step 14: outputting a constructed CNN ensemble model.

The CNN ensemble model is a deep ensemble model for image classification.

Optionally, in the method for generating a deep ensemble model provided by the embodiments of the present disclosure, when the differential evolution operation is performed, two classes of mutation operators and two classes of crossover operators that are modified may be used. An operator can balance the exploration and development of a method such that complex neuron ensemble architecture issues can be handled.

Thus, the above step 02 may include the following steps.

Step 21: altering each overall CNN model structure in the trained first group of CNN models based on a first mutation operator.

It needs to be noted that the first mutation operator tends to global search.

The first mutation operator may be described by Formula (2):

$${\vec{v}}_{t}^{{j}_{1}} = \{ \begin{matrix}{\vec{y}}^{{r}^{1}} + F \cdot ( {\vec{y}}^{{r}^{2}} - {\vec{y}}^{{r}^{3}} ) , & rang ( 0 , 1 ) \leq r \\ {\vec{y}}^{{j}_{1}} + F \cdot \vec{d} , & others\end{matrix} \qquad ( 2 )$$

where, j₁ represents an index of a CNN model j₁ in a population;

$${\vec{v}}_{t}^{{j}_{1}}$$

represents a mutation intermediate obtained after mutation of the CNN model j₁ in the population at a generation t; \vec{y}^{h} represents the CNN model j₁ in the population; \vec{y}^{r}^{¹}, \vec{y}^{r}^{²}, and \vec{y}^{r}^{³} represent random neighbor CNN models randomly selected from a neighborhood of y̅^{j}^{¹}; F represents a factor for controlling a range of a mutated CNN model; r represents a real number in [0, 1] randomly generated by a random number generator rand(0,1); \vec{d} represents a vector

$$\vec{d} = {\vec{y}}_{t - 1}^{best} - {\vec{y}}_{t - 2}^{best}$$

of a change direction of an optimal solution;

$${\vec{y}}_{t - 1}^{best} and {\vec{y}}_{t - 2}^{best}$$

correspond to optimal solutions of generations t−1 and t−2; and t represents a current iteration round.

Step 22: altering a single convolutional block in each CNN model in the trained first group of CNN models based on a second mutation operator.

Specifically, a bit of a CNN model is selected randomly, and this bit is altered to a feasible value.

The first mutation operator and the second mutation operator are different values of a target mutation operator.

Step 23: swapping an original CNN model and a convolutional block of the original CNN model based on a first crossover operator.

Step 24: swapping a random bit of the original CNN model based on a second crossover operator.

The first crossover operator is expressed by the following Formula (3):

$$\begin{matrix}\text{?} \\ {u}_{{j}_{2}}\end{matrix} = \{ \begin{matrix}{v}_{j 2} ; & rand ( 0 , 1 ) \leq CR , {j}_{2} = 3 {r}_{i 2} 3 {r}_{i 2} + 1 , or 3 {r}_{i 2} + 2 \\ {w}_{j 2} ; & others\end{matrix} \qquad ( 3 )$$

$$\text{?} \text{indicates text missing or illegible when filed}$$

where, rᵢ₂=randI(0,2); rᵢ₂ represents an integer i₂ randomly generated by a random integer generator randI(0,2) within a range [0, 2]; CR represents a preset crossover probability factor; j₂ represents an index of a variable dimension j₂; uⱼ_{₂} represents a result of a first crossover operator j₂; vⱼ_{₂} represents a dimension j₂ of a mutated solution of the target mutation operator; and wⱼ_{₂} represents a dimension j₂ of an original candidate solution of the target mutation operator.

It needs to be noted that, in an embodiment of the present disclosure, CR is a parameter for controlling a crossover strategy. If a random number is less than CR, a crossover result is a first term of the formula; and if the random number is greater than or equal to CR, the crossover result is a second term. That is, CR is used for balancing the exploration and search of the method.

The second crossover operator may be expressed by the following Formula (4):

$${u}_{{j}_{3}} = \{ \begin{matrix}{v}_{j 3} ; & rand ( 0 , 1 ) \leq CR \\ {w}_{j 3} ; & others\end{matrix} \qquad ( 4 )$$

where, uⱼ_{₃} is represents a result of a second crossover operator j₃; vⱼ_{₃} represents a dimension j₃ of the mutated solution of the target mutation operator; and wⱼ_{₃} represents a dimension j₃ of the original candidate solution of the target mutation operator.

Optionally, in the method for generating a deep ensemble model provided by the embodiments of the present disclosure, the above step 104 may include the following steps.

Step 31: evaluating the second group of CNN models based on a first objective function and a second objective function, and constructing the deep ensemble model for image classification.

It will be appreciated that a task of constructing the deep ensemble model is modeled as the bi-objective optimization problem in the embodiments of the present disclosure, where the first objective function is configured to determine the accuracy of the deep ensemble model, and the second objective function is configured to determine the diversity of the deep ensemble model.

The first objective function may be expressed by the following Formula (5):

$$a c c ( x ) = \frac{1}{N} {\sum }_{{i}_{1} = 1}^{\vert G \vert} {\sum }_{s : gx ( s ) = {i}_{1}} I ( {g}_{x} ( s ) = \hat{g} ( s ) ) \qquad ( 5 )$$

where, N represents a number of test samples; |G| represents a number of test sample types; i₁ represents a test sample i₁; x represents a solution of a test sample s; gₓ(s) represents a classification result of the solution x of the test sample s; ĝ(s) represents a real class of the test samples; I(.) represents a discrimination function;
and when gₓ(s)=ĝ(s), 1 is returned, or otherwise, 0 is returned.

The second objective function may be expressed by the following Formula (6):

$$d ( x ) = {\sum }_{{i}_{4} = 1}^{m} {\sum }_{{{j}_{4} = {j}_{4} + 1}^{}}^{m} ( \sqrt{{\sum }_{k = 1}^{d} {( {a}_{{i}_{4}}^{k} - {a}_{{j}_{4}}^{k} )}^{2}} + {\sum }_{p = 1}^{\vert G \vert} I ( g ( {a}_{{i}_{4}} , {s}_{p} ) = g ( {a}_{{j}_{4}} , {s}_{p} ) ) ) \qquad ( 6 )$$

where, represents an output of a head i₄ of the deep ensemble model;

$${a}_{{i}_{4}}^{k}$$

represents an architecture of a k-th dimension of the head i₄;

$${a}_{{j}_{4}}^{k}$$

represents an architecture of the k-th dimension of the head j4; g(aᵢ_{₄},sₚ) represents an output of aᵢ_{₄} on a p-th test sample sₚ; d represents a dimension of a code of a head;

$$\sqrt{{\sum }_{k = 1}^{d} {( {a}_{{i}_{4}}^{k} - {a}_{{j}_{4}}^{k} )}^{2}}$$

represents a Euclidean distance between the head i4 and the head j4; and

$${\sum }_{p = 1}^{\vert G \vert} I ( g ( {a}_{{i}_{4}} , {s}_{p} ) = g ( {a}_{{j}_{4}} , {s}_{p} ) )$$

represents a number of test samples with different classification results.

In an embodiment of the pressure disclosure, multi-objective optimization may be performed, where for each CNN model, a CNN model is randomly selected as a shared layer from the second group of CNN models, and then an offspring population is generated using DE based on a neighborhood and a binomial crossover operator. The external archive stores non-dominated solutions meeting a preset objective function; if a first candidate solution of candidate solutions of the preset objective function meets that there are no other candidate solutions superior to the first candidate solution on two optimization objectives, namely the first objective function and the second objective function, the first candidate solution is the non-dominated solution; and the first candidate solution is any candidate solution.

The preset objective function (the external archive) has the non-dominated solutions meeting the following formula (7):

$$¬ ∃ {x}_{{j}_{5}} ∈ W , {j}_{5} \neq {i}_{5} , ∀ {x}_{{j}_{5}}^{k} \geq {x}_{{i}_{5}}^{k} \qquad ( 7 )$$

where, xⱼ₅ is represents a candidate solution j₅, W represents a set of candidate solutions,

$${x}_{{i}_{5}}^{k}$$

represents the k-th dimension of a candidate solution i₅, namely xᵢ_{₅}, and

$${x}_{{j}_{5}}^{k}$$

represents the k-th dimension of the candidate solution j₅, namely xⱼ_{₅}.

It will be appreciated that, for each iteration, a next-generation parent population is constructed by crowding distance-based non-dominated sorting, finally CNN models with the highest classification accuracy in the external archive are decoded into a CNN model set, and the CNN model ensemble is output, and this CNN model ensemble indicates the CNN models of the deep ensemble model.

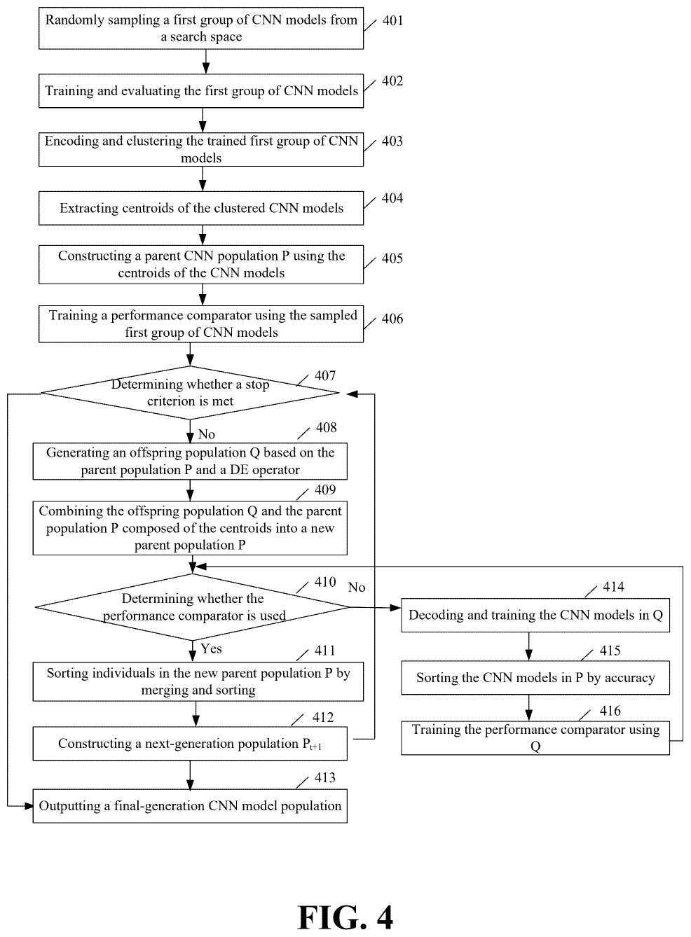

Exemplarily, the method for generating a deep ensemble model provided by the embodiments of the present disclosure includes two major stages. The first stage is an initialization stage, which employs a data-driven CNN model initialization strategy based on clustering, and may include the following steps with reference to FIG. 4.

Step 401: randomly sampling, from a search space, a first group of CNN models.

Step 402: training and evaluating the first group of CNN models.

Step 403: encoding and clustering the trained first group of CNN models.

Step 404: extracting the centroids of various classes of the clustered CNN models.

Step 405: constructing a parent CNN population P using the centroids of various classes of the CNN models.

Step 406: training a performance comparator using the sampled first group of CNN models.

Step 407: determining whether a stop criterion is met.

Step 408: if the stop criterion is not met, generating an offspring population Q based on the parent population P and a DE operator.

Step 409: combining the offspring population Q and the parent population P into a new parent population P.

Step 410: determining whether the performance comparator is used.

Step 411: if the performance comparator is used, sorting the new parent population.

Step 412: constructing Pₜ₊₁ by tournament selection.

Step 413: if the stop criterion is met, outputting a final generation.

Step 414: if the performance comparator is not used, decoding and training the CNN models in the offspring population Q.

Step 415: sorting the CNN models in the parent population P based on accuracy.

Step 416: training the performance comparator using the offspring population Q.

After the training is completed, the step 410 is performed again to determine whether the trained performance comparator is used.

In the method for generating a deep ensemble model provided by the embodiments of the present disclosure, firstly, a plurality of CNN models are randomly sampled, and then trained using the training dataset; the trained plurality of CNN models are then tested using the validation dataset; subsequently, the validated plurality of CNN models and their respective error rates are encoded as the real vectors; the encoded vectors are then classified into N classes using the clustering method, where the centroid of each of the N classes constitutes the initial CNN model for next-generation DE.

It needs to be noted that the aforementioned population initialization method can find a promising candidate regional scheme so that the initialization efficiency can be improved. By clustering the encoded vectors, i.e., clustering the CNNs, the diversity of the parent populations can be maintained, avoiding the problem of local optimization.

It needs to be noted that, in the method for generating a deep ensemble model provided by the embodiments of the present disclosure, the population size is denoted as N, and the time complexity of population generation is denoted as O(N). If the surrogate model selects GBDT, the time complexity of model training is O(2KN log N), K is the number of trees, and the time complexity of performance evaluation is O(N log N) The time complexity of generating the second group of CNN models is O(2TKN log N), T is the number of iterations, and the time complexity of generating the deep ensemble model based on the second group of CNN models is O(TN log N) Accordingly, the total time complexity is O(2TKN log N)

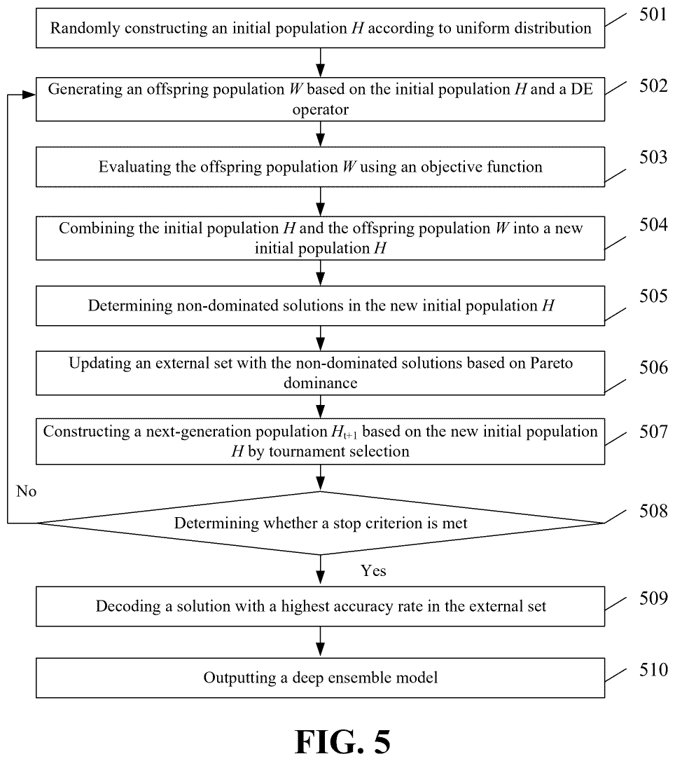

The second stage is to generate a deep ensemble model based on a group of CNN models selected at the first stage, and includes the following steps with reference to FIG. 5.

Step 501: randomly constructing an initial population H according to uniform distribution.

In an embodiment of the present disclosure, a parent population may also be called an initial population.

Step 502: generating an offspring population W based on the initial population H and a DE operator.

Step 503: evaluating the offspring population W using an objective function.

Step 504: combining the initial population H and the offspring population W into a new initial population H.

Step 505: determining non-dominated solutions in the new initial population H.

Step 506: updating an external set with the non-dominated solutions based on Pareto dominance.

Step 507: constructing a next-generation population Hₜ₊₁ based on the new initial population H by tournament selection.

Step 508: determining whether a stop criterion is met.

Step 509: if the stop criterion is met is met, decoding a solution with a highest accuracy rate in the external set.

Step 510: outputting the deep ensemble model.

If the stop criterion is not met, the above step 502 is performed again based on the next-generation population Hₜ₊₁.

The following presents a code example for implementing the method for generating a deep ensemble model provided by the embodiments of the present disclosure, where a first part is a code for generating the second group of CNN models, and a second part is a code for constructing the deep ensemble model based on the second group of CNN models.

### First Part:

Algorithm1: Stageone: candidateCNNgeneration

Input: Search space Q
Output: AgroupofheterogeneousCNNs
1randomly sample a group of CNNs;
2trainandevaluatethe sampled CNNs;
3encodeandcluster the trained CNNs;
4extract the centroids of the CNNs;
5use the centroids to construct the initial population;
6trainthe performance comparator using the sampled CNNs;
7whilestopcriterionisnotmetdo
8generate an offspring population Qby DE operators;
9merge Qand Pas P;
10ifuseperformancecommparatorthen
sort Pby merge sort;
12else
13decodeandtrainindividuals in Q;
14sort Pby accuracy;
15train the performance comparator using Q;
16end
17construct Pt+1 by tournament selection;
18end
19outputthelast generation;

### Second Part:

Algorithm2: Stage two: CNN ensemble construction

Input:Agroup of heterogeneous CNNs H
Output:ACNN ensemble
1randomly construct the initial population;
2whilestopcriterionisnotmetdo
3generate an offspring population Wby DE operators;
4evaluate W;
5merge Wand Has H;
6select non-dominated solutions fromH;
7update the external archive by non-dominated solutions;
8construct Ht+1 by tournament selection;
9end
10decodethesolutionwithhighestaccuracyintheexternalarchive;
11output the CNN ensemble;

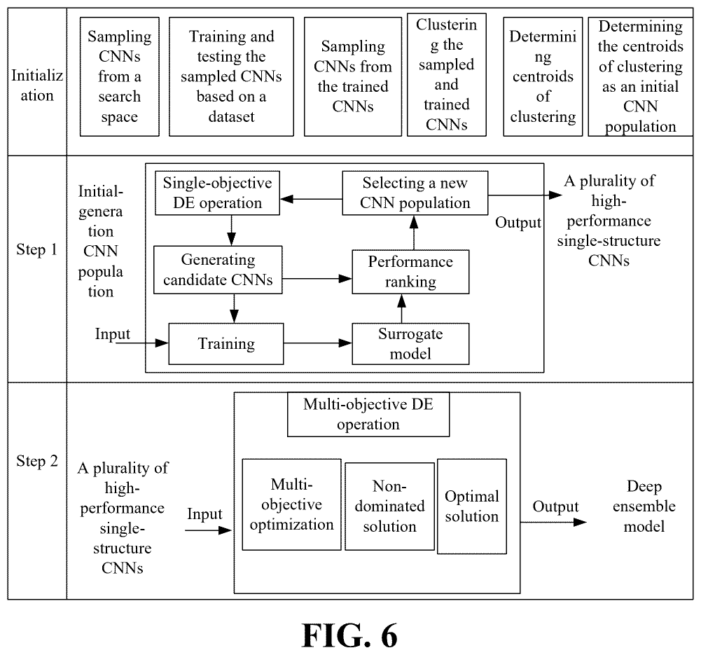

FIGS. 4 to 6 are schematic diagrams showing a method execution logic based on the foregoing method embodiments. Initialization, step 1, and step 2 are included.

The following is an example of a deep ensemble model for an image classification task generated based on the embodiments of the present disclosure.

CIFAR-10 and CIFAR-100 are used as benchmark datasets.

CIFAR-10 includes 60000 images, classified into a total of 10 classes, and each image has 32*32 pixels, where a training set includes 48000 image samples, a test set includes 10000 image samples, and a validation set includes 2000 image samples.

CIFAR-100 includes 100 classes, each including 600 image samples, where a training set includes 450 image samples in each class, a test set includes 100 image samples in each class, and a validation set includes 50 image samples in each class.

Experimental validation may be performed based on PyTorch1.6.0 on a workstation with configurations of Intel® Core™ i7-9700K CPU, NVIDIA RTX2080 GPU, and a 32 GB memory.

Table 2 is an exemplary table of parameter configuration of a DE differential evolution operator in the embodiments of the present disclosure.

TABLE 2

| | Value | Value |
|---|---|---|
| Parameter | Step 1 | Step 2 |
| Population size | 20 | 20 |
| Mutation rate | 0.5 | 0.5 |
| Fractional frequency | 0.7 | 0.8 |
| Number of iterations | 20 | 40 |

The aforementioned parameter values are set according to previous experience and the typical studies of the researchers in the art. Due to the complicated architecture search problem, the crossover rate is greater than 0.5 so that a stronger global search capability is obtained.

Table 3 shows parameter settings for the clustering method provided by the embodiments of the present disclosure and CNN model training.

TABLE 3

| Parameter | Parameter | Value |
|---|---|---|
| Clustering | Hybrid iterations | 200 |
| | Number of samples | 80 |
| Training of | Batch size | 64 |
| candidate CNN | Number of iterations | 80 |
| models | Initial learning rate | 3*10⁻⁴ |
| | β₁ of Adam optimizer | 0.5 |
| | β₂ of Adam optimizer | 0.999 |
| Training of | Batch size | 128 |
| deep ensemble | Number of iterations | 300 |
| model | Initial learning rate | 0.1 |
| | Momentum coefficient (momentum | 0.9 |
| | parameter?) | |

It needs to be noted that the embodiments of the present disclosure provide exemplary explanation of the influence of the number of heads on the method. When the number m of the heads is set to 3, 5, and 10, the method for generating a deep ensemble model provided by the embodiments of the present disclosure is performed for 10 times, and obtained execution results are as shown in Table 4. Table 4 shows the influences of the number of heads on the classification error rate and the number of parameters of the CNN set. As can be seen from the table, the parameters increase with increasing number of heads, and the error rate is negatively correlated with the number of heads.

TABLE 4

| | |
|---|---|
| CIFAR-10 | CIFAR-100 |

| Number of | Number of | Error | Number of | Error |
|---|---|---|---|---|
| Heads | Parameters | rate | Parameters | Rate |
| 3 | 2.8 | 5.36 | 6.5 | 21.98 |
| | | (4.94) | | (20.37) |
| 5 | 4.1 | 2.65 | 9.2 | 16.82 |
| | | (2.08) | | (15.96) |
| 10 | 7.9 | 2.12 | 27.9 | 16.04 |
| | | | | (15.43) |

As can be seen from Table 4, the error rate for 3 heads is highest, and the number of parameters for 5 heads is twice and more than that for 3 heads. However, the error rates are close in the two cases.

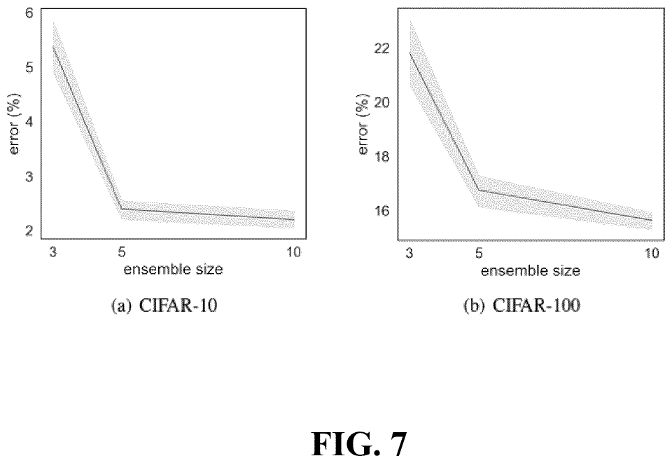

FIG. 7 is a schematic diagram of a trend of error rates provided by the embodiments of the present disclosure, where a line represents the change trend of the error rates, and a filled area represents a distribution range of experimental results. On CIFAR-10 and CIFAR-100, when m is equal to 5 and 10, the experimental results are more stable and concentrated than those when m is equal to 3. When m is equal to 10, the error rate is lower than that when m is equal to 5. Compared with the case when m is equal to 3, this difference is not obvious. Considering the parameter of parameters is huge when m is equal to 10, m is set to 5 in subsequent experiments unless otherwise specified.

In this experiment, the layer shared CNN ensemble model is compared with the ensemble model constructed directly from candidate CNN models. Table 5 is an exemplary table of a layer sharing effect provided by the embodiments of the present disclosure.

TABLE 5

| | CIFAR-10 | | CIFAR-100 | |
|---|---|---|---|---|
| | Number of | Error | Number of | Error |
| Ensemble Type | Parameters | Rate | Parameters | Rate |
| Direct | 28.6 | 2.72 | 44.5 | 17.54 |
| construction | | (2.15) | | (16.08) |
| Layer sharing | 4.1 | 2.65 | 9.2 | 16.82 |
| | | (1.97) | | (15.06) |

| | | |
|---|---|---|
| p-value | 3.86E−2 | 1.03E−2 |

Table 5 shows the layer sharing effect. Average values of the parameters of each model are listed. With regard to the error rate, digits between parentheses represent an average value and an optimal result. The significant differences between different methods are studied using a Wilcoxon signed rank test in the present disclosure. A last row of Table 6 shows results of the Wilcoxon test. In this experiment, the confidence level is set to 0.05. When the p value is lower than 0.05, it is considered that there are significant differences between result distributions of different methods. Without the layer sharing strategy, the number of parameters for CIFAR-10 is 6.96 times greater than that for the layer shared CNN model set, and the number of parameters for CIFAR-100 is 4.84 times greater than that for the layer shared CNN model set. Moreover, significantly better error rates may be obtained by applying layer sharing to CIFAR-10 and CIFAR-100. Therefore, the performance of DENE in terms of classification accuracy and efficiency can be improved by using the layer sharing strategy.

An embodiment of the present disclosure provides a data-driven CNN model initialization strategy based on clustering. Table 6 is an exemplary table of the influence of initialization of a CNN model provided by an embodiment of the present disclosure.

TABLE 6

Error Rate (%)

| Ensemble Model | CIFAR-10 | CIFAR-100 |
|---|---|---|
| Random initialization | 3.52 (3.09) | 18.48 (18.34) |
| Initialization of the | 2.65 (1.97) | 16.82 (15.06) |
| present disclosure | | |
| p-value | 2.84E−2 | 1.37E−2 |

Table 6 compares error rates of randomly initialized and DENE generated CNN ensemble models. Experimental results show that when the provided CNN model strategy based on clustering is used, the method provided by the embodiments of the present disclosure obtains better average and optimal error rates.

Table 7 is an exemplary table of an influence of a performance ranking strategy provided by an embodiment of the present disclosure.

TABLE 7

| | CIFAR-10 | | CIFAR-100 | |
|---|---|---|---|---|
| | Search | Error | Search | Error |
| Ensemble Type | Time | Rate (%) | Time | Rate (%) |
| All training | 19.7 | 2.68 (1.90) | 22.1 | 16.81 (15.11) |
| Performance ranking | 17.0 | 2.65 (1.97) | 18.1 | 16.82 (15.06) |

| | | |
|---|---|---|
| p-value | 4.53E−1 | 9.92E−2 |

Table 7 shows an effect of the performance ranking strategy based on the surrogate model and compares the search times and the error rates. The performance ranking strategy can save model search time by 13.70% on CIFAR-10 and 18.10% on CIFAR-100. Furthermore, on CIFAR-10 and CIFAR-100, the Wilcoxon test shows that there is no significant difference in error rate between the method provided by the present disclosure and the method of completely training all candidate CNN models. Therefore, the performance ranking strategy can save the model search time while not affecting the performance of the ensemble model.

Table 8 is an exemplary table of comparison on classification accuracy provided by an embodiment of the present disclosure.

TABLE 8

| | | | | Error Rate (%) | |
|---|---|---|---|---|---|
| Algorithm | Year | Type | Parameter | CIFAR-10 | CIFAR-100 |
| NSGANet | 2019 | Single | 4 | —(2.02) | / |
| | | | 4.1 | / | —(15.08) |
| DeepMaker | 2020 | Single | 1 | 6.90(6.60){5.06E−4} | |
| | | | 1.89 | / | 24.87(24.63){5.06E−4} |
| EPSOCNN | 2020 | Single | 4.79 | 3.74(3.72){3.97E−3} | / |
| | | | 4.79 | / | 19.05(18.86){7.02E−4} |
| EEEA-Net | 2021 | Single | 3.6 | —(2.76){—} | / |
| | | | 3.6 | / | —(15.02)— |
| SaMu-Net | 2021 | Single | 1.5 | —(3.6){—} | / |
| | | | 4.6 | / | —(20.2){—} |
| MFENAS | 2022 | Single | — | 5.63(5.63){7.02E—4} | / |
| | | | — | / | 26.49(26.49){7.02E−4} |
| DeepENS | 2016 | Single | — | 10.50(7.33){4.28E−4} | / |
| | | | 4.2 | / | 20.52(19.84){3.79E−3} |
| NES-RS | 2020 | Ensemble | — | 10.50(6.87){4.28E−4} | / |
| | | | 4.0 | / | 19.75(18.58){3.79E−3} |
| HyperDeepEns | 2021 | Ensemble | — | 9.83(7.33){4.28E−4} | / |
| | | | 4.2 | / | 20.11(19.88){3.79E−3} |
| MH-ENS | 2021 | Ensemble | 2.0 | 4.17(3.54){2.86E−3} | / |
| | | | 2.7 | / | 19.65(17.37){8.47E−3} |
| DENE | | Ensemble | 4.1 | 2.65(1.97) | / |
| | | | 7.2 | / | 16.82(15.06) |

Table 8 compares the error rates and the numbers of parameters of the present disclosure and the most advanced evolutionary NAS algorithm and neuron ensemble search algorithm. In each of cells of a fifth column and a sixth column, digits before and after parentheses represent an average error rate and an optimal error rate in repeating independent running, respectively. Digits in braces are p values of the Wilcoxon signed rank test. Optimal ones of comparison results are bold. Some algorithms only report one error rate result. This study regards the result as the optimal error rate. The symbol “−” represents that this indicator is not reported in related literature. The proposed algorithm is compared with six single neural structure algorithms (NSGANet, DeepMaker, EPSOCNN, EEEA-Net, SaMuNet, and MFENAS) and four NEAS algorithms (DeepEns, NES-RS, HyperDeepEns, and MH-NES). Since this study does not obtain the results of all the algorithms, some algorithms are not included in the comparison by the Wilcoxon test. Table 8 indicates that a small model is generated on CIFAR-10 while a relatively large model is generated on CIFAR-100 in the embodiments of the present disclosure. The ensemble model generated in the embodiments of the present disclosure is larger than DeepEns, NES-RS, HyperDeepEns, and MH-NES. Correspondingly, the classification error rate shown by the embodiments of the present disclosure is lower than those of other ensemble models on CIFAR-10 and CIFAR-100. Compared with the ENAS algorithm, the embodiments of the present disclosure exhibit the optimal average error rate and the lowest error rate on CIFAR-10, and exhibit the lowest average error rate on CIFAR-100. According to the p values, the embodiments of the present disclosure are significantly superior to the compared NEAS algorithms on CIFAR-10 and CIFAR-100. Furthermore, the error rates shown by the embodiments of the present disclosure are better than those of the three ENAS methods. Although the error rate of NSGANet is close to that of the embodiments of the present disclosure and the optimal error rate of EEEA-Net is the lowest one among all the algorithms, the missing of their independently copied experimental statistical data makes the evaluation of the performance and stability of the algorithms difficult. Therefore, the embodiments of the present disclosure usually exhibit competitiveness or better classification accuracy.

Table 9 is an exemplary table of comparison on search time provided by the embodiments of the present disclosure.

TABLE 9

Search Time (GPU)

| Algorithm | CIFAR-10 | CIFAR-100 |
|---|---|---|
| HyperDeepEns | 14.7 | 28.7 |
| NES-RS | 14.8 | 15.2 |
| MH-NES | 22.4 | 23.5 |
| DENE | 17.0 | 18.1 |

Table 9 compares the embodiments of the present disclosure with DeepEns, NES-RS, and MH-NES on execution time. All the algorithms are implemented on the same device. In the present disclosure, each algorithm is independently run for ten times. The table displays an average result of the search time. The embodiments of the present disclosure take 17.0 GPU hours to generate the CNN ensemble model on CIFAR-10, while taking 18.1 hours on CIFAR-100. The time consumed by DENE is less than that consumed by MH-NES, but more than that consumed by DeepEns and NES-RS. According to Table 9, the number of parameters of the model generated in the embodiments of the present disclosure is greater than those of DeepEns and NES-RS.

The experimental results indicate that the method for generating a deep ensemble model provided by the embodiments of the present disclosure has competitive performance than the currently advanced evolution NAS algorithms and NES algorithms in deep ensemble models in which image classification tasks are automatically constructed.

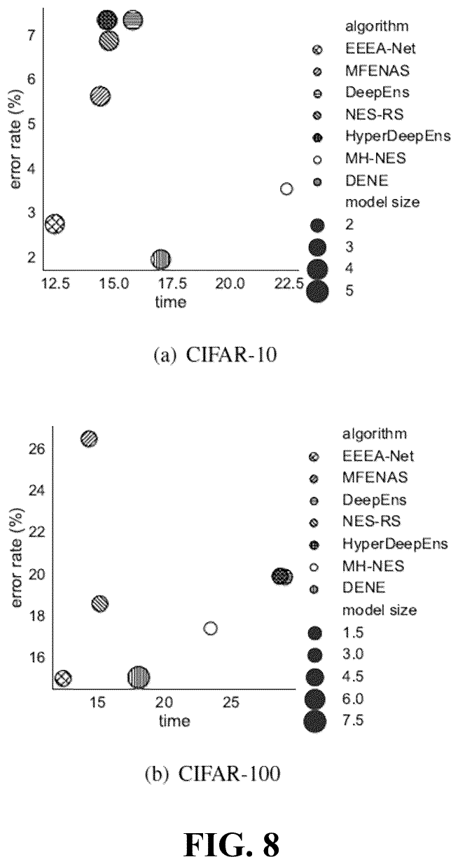

The processing approach based on clustering in the embodiments of the present disclosure can improve the classification accuracy of the CNN ensemble model. By the processing approach with the multi-head architecture and the shared layer, the computing resources can be saved, and the number of parameters of the generated deep ensemble model can be reduced. The search time of the deep ensemble model can be saved by using a performance ranking approach based on the surrogate model. FIG. 8 is a schematic diagram of comparison on an error rate and a search time provided by the embodiments of the present disclosure, in which the error rates and the model search times of the method provided in the embodiments of the present disclosure and the typical algorithms are specifically compared. A size of each dot represents a size of the generated deep model. The closer to the coordinate axis, the better the processing performance. As shown in FIG. 8, the embodiments of the present disclosure achieve a good balance between the classification accuracy and the execution time. NSGANet, DeepMaker, and SaMuNe are not listed in the figure because their execution times are much longer than those of other algorithms. However, the embodiments of the present disclosure have no advantage in terms of the number of parameters, which limits the application scenarios of the model.

The images in CIFAR-100 are classified into 20 superclasses, each including five image classes. Herein, three classes of each superclass are used as the training set, while the other two classes are used as the test set. Therefore, the training and test datasets have some common features and also some differences. In this case, the present disclosure may use CIFAR-100 to study performance of an ensemble classifier when data changes. That is, the observed data distribution is different from the training data, and the performance is used to reflect the generalization capability of the model.

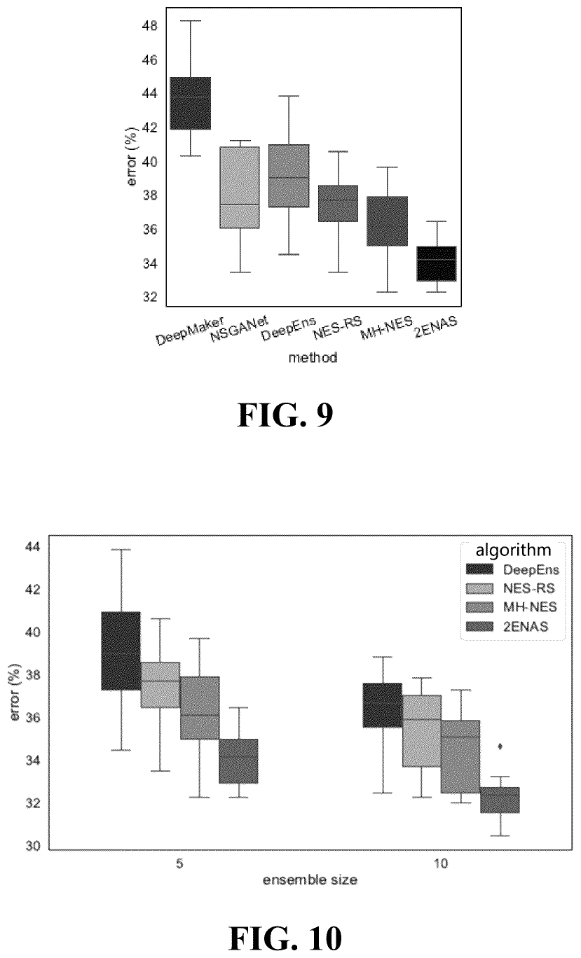

FIG. 9 is a schematic diagram of comparison on an error rate. DENE is compared with DeepMaker, NSGANet, DeepEns, NES-RS, and MH-NES with respect to the error rate. A block corresponding to DENE is narrow, indicating that experimental results generated by DENE are more concentrated. Furthermore, the block of DENE is in a lower position than other blocks, that is, the CNN model ensemble generated by DENE has a lower error rate. Therefore, DENE has a more excellent generalization capability than other tested algorithms.

FIG. 10 is a schematic diagram showing an influence of a number of basic classifiers on the generalization capability. In the present disclosure, the error rates are compared when m is equal to 5 and 10. As shown in FIG. 9, when m is equal to 10, the blocks of DENE and DeepEns are narrower than those when m is equal to 5. Furthermore, when m is equal to 10, the error rates of all the algorithms are lower. Therefore, increasing the number of the basic classifiers is helpful for improving the generalization capability. In all the tested algorithms, DENE has the lowest and most stable classification error rate on offset data.

The experimental results indicate that DENE can generate a CNN model ensemble having competitiveness or a better classification accuracy rate within one GPU day. Furthermore, DENE has stable results on the offset data. Therefore, DENE can generate a CNN model ensemble having high precision and a strong generalization capability.

According to an ablation experiment, the layer sharing strategy reduces the number of parameters of the neural ensemble. The proposed performance ranking strategy reduces the execution time of DENE and has no significant influence on the classification accuracy of the CNN model ensemble. Furthermore, the proposed population initialization strategy significantly improves the classification accuracy on CIFAR-10 and CIFAR-100. Therefore, on the basis of a DE framework, DENE improves the efficiency and performance of the original DE on the NEAS problem by improving key operations and strategies of a traditional DE.

The DENE provided in the embodiments of the present disclosure is to search, at two stages, the neural structure of the CNN model set. When a single search process is used, the shared layer and the head structure are searched at the same time. Moreover, in order to maintain the diversity of the neural ensemble, in this case, the search process will become complicated. DENE is to generate, at the first stage, a group of high-precision CNN models for constructing the neural ensemble of the second stage. Since the first stage is a single-objective optimization process, the algorithm has a relatively high convergence rate. At the second stage, the precision and the diversity of the CNN model ensemble is balanced through a multi-objective optimization process. Since the second stage is a combination problem with a small-scale search space, weight parameters of the candidate CNN models can be reused, and multi-objective optimization does not consume too much time and too many computing resources.

DENE has a fixed number of shared blocks, which is a tradeoff between performance and algorithm efficiency. The introduction of more layer sharing modes will increase the number of dimensions of the search space, resulting in an exponential increase in the search time. However, the fixed number of layers limits the diversity of the neural ensemble and the flexibility of the algorithm. For subsequent studies, designing an efficient method with variable shared layers is a promising direction.

DENE is proposed herein, which is a differential evolution algorithm for neural ensemble architecture search. DENE is to automatically construct the neural ensemble of image classification tasks at two stages. The experimental results indicate that the proposed algorithm has the competitive performance on CIFAR-10 and CIFAR-100 as compared with the most advanced evolution NAS algorithms and NEAS algorithms. With the multi-head architecture and the shared layer, the computing resources can be saved and the number of parameters can be reduced. The proposed performance ranking strategy based on the surrogate model saves the search time of DENE. Furthermore, the initialization strategy based on clustering can improve the classification accuracy of the CNN set. Regarding the future studies, the classification performance of the CNN ensemble can be further improved by improving the diversity of the head structure and designing a more flexible layer sharing strategy.

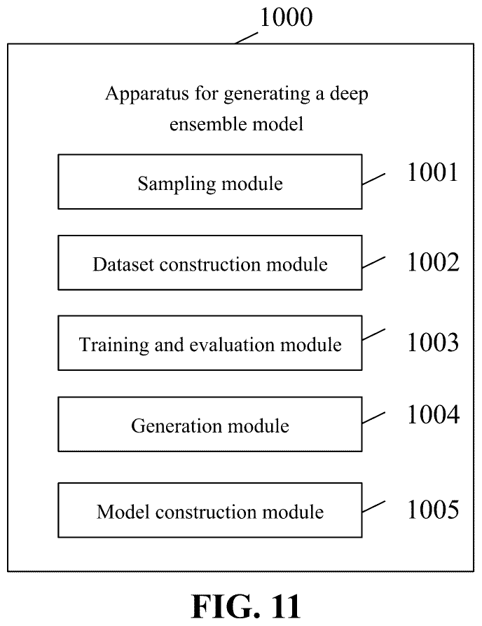

FIG. 11 is a block diagram of an apparatus for generating a deep ensemble model illustrated according to an exemplary embodiment of the present disclosure. The apparatus 1000 includes a sampling module 1001, a dataset construction module 1002, a training and evaluation module 1003, a generation module 1004, and a model construction module 1005. The sampling module 1001 is configured to randomly sample, from a search space of classical CNN models for image classification, a neural architecture of a first group of CNN models. The dataset construction module 1002 is configured to collect representative image samples based on a scenario of an image classification task, mark the collected image samples with classification labels, and construct a training dataset based on the marked image samples, where the image classification task includes at least one of visual search, image tagging, content filtering, medical image analysis, security surveillance, agricultural monitoring, and environmental detection. The training and evaluation module 1003 is configured to train the sampled first group of CNN models based on the training dataset and evaluate image classification performance of the sampled first group of CNN models.

The generation module 1004 is configured to generate a second group of CNN models based on a surrogate model and the trained first group of CNN models. The model construction module 1005 is configured to generate a structure of a deep ensemble model for image classification based on the second group of CNN model and a multi-objective optimization strategy, where the structure of the deep ensemble model includes a shared block.

Optionally, the generation module is specifically configured to generate the second group of CNN models based on a single-objective differential evolution operation, the surrogate model, and the trained first group of CNN models.

Optionally, the generation module is specifically configured to: encode and cluster the trained first group of CNN models, and extract centroids of clustering for constructing a first parent population; train a performance comparator using the sampled first group of CNN models; if a training stop criterion is not met, generate a first offspring population by the single-objective differential evolution operation; combine the first parent population and the first offspring population into a new first parent population; determine whether the performance comparator is used; if the performance comparator is used, sort the new first parent population using a merging and sorting approach of the surrogate model, and construct a next-generation population by tournament selection; and if the training stop criterion is met, output a final-generation population, where the final-generation population is the second group of CNN models.

Optionally, the generation module is further configured to: after determining whether the performance comparator is used, if the performance comparator is not used, decode and train the CNN models in the first offspring population; sort the new first parent population by accuracy; and train the performance comparator using the first offspring population, where at intervals of T iterations, the CNN models of the new first parent population are not evaluated and sorted with respect to performance using the trained performance comparator; the CNN models of the new first parent population are trained using the training dataset, true accuracy rates of the CNN models of the new first parent population are tested using a validation dataset, candidate solutions are sorted according to the trained performance comparator, and a high-quality candidate solution is selected; and incremental training is performed on the trained performance comparator using a neural architecture code of the CNN models of the new first parent population and corresponding sorted accuracy rates as training data; or in other cases, performances of the CNN models of the new first parent population are evaluated and sorted with respect to performance using the trained performance comparator.

Optionally, the model construction module is specifically configured to construct the structure of the deep ensemble model for image classification based on a bi-objective differential evolution operation, the second group of CNN models, and the multi-objective optimization strategy.

Optionally, the model construction module is specifically configured to: randomly construct a second parent population based on the second group of CNN models; if a stop criterion is not met, perform a bi-objective differential evolution operation on the second group of CNN models to generate a second offspring population; evaluate the second offspring population, and combine the second offspring population and the second parent population into a new second parent population; select, from the new second parent population, non-dominated solutions to a current multi-objective optimization problem, where for any non-dominated solution, no any solution that is superior to the non-dominated solution on all optimization objectives is present in the new second parent population; update an external archive to save the non-dominated solutions; construct a next-generation population by tournament selection; if the stop criterion is met, decode a solution with the highest accuracy in the external archive; and output a constructed CNN ensemble model, where the CNN ensemble model is a deep ensemble model for image classification.

Optionally, the generation module is specifically configured to encode each CNN model in the trained first group of CNN models and an error rate corresponding to each CNN model as a real vector, and cluster the encoded real vectors into a plurality of classes, where the error rate is expressed as

$$minimize f ( x ) = 1 - \frac{1}{N} {\sum }_{{i}_{1} = 1}^{\vert G \vert} {\sum }_{s : {g}_{x} ( s ) = {i}_{1}} I ( {g}_{x} ( s ) = \hat{g} ( s ) ) ,$$

where, N represents a number of test samples; |G| represents a number of test sample types; i₁ represents a test sample i₁; x represents a solution of a test sample s; gₓ(s) represents a classification result of the solution x of the test sample s; ĝ(s) represents a real class of the test sample s; I(.) represents a discrimination function; and when gₓ(s)=ĝ(s), 1 is returned, or otherwise, 0 is returned.

Optionally, the search space of the CNN models includes four convolutional blocks and one pooling layer; a structure of each convolutional block is determined by hyperparameters of the convolutional block that include at least one of a convolutional unit type, a convolutional layer channel expansion factor, and a convolutional layer repeat count; and the generation module is further configured to encode each CNN model as an integer array of a fixed length according to the hyperparameters of each convolutional block.

Optionally, the generation module is specifically configured to: alter each overall CNN model structure in the trained first group of CNN models based on a first mutation operator; or alter a single convolutional block in each CNN model in the trained first group of CNN models based on a second mutation operator.

Optionally, the first mutation operator and the second mutation operator are different values of a target mutation operator which is expressed as:

$${\vec{v}}_{t}^{{j}_{1}} = \{ \begin{matrix}{\vec{y}}^{{r}^{1}} + F \cdot ( {\vec{y}}^{{r}^{2}} - {\vec{y}}^{{r}^{3}} ) , & rang ( 0 , 1 ) \leq r \\ {\vec{y}}^{{j}_{1}} + F \cdot \vec{d} , & others\end{matrix} ,$$

where, j₁ represents an index of a CNN model j₁ in a population;

$${\vec{v}}_{t}^{{j}_{1}}$$

represents a mutation intermediate obtained after mutation of the CNN model j₁ in the population at a generation t; \vec{y}^{j}^{₁} represents the CNN model j₁ in the population; \vec{y}^{r}^{¹}, \vec{y}^{r}^{²}, and \vec{y}^{r}^{³} represent random neighbor CNN models randomly selected from a neighborhood of \vec{y}^{j}^{¹}; F represents a factor for controlling a range of a mutated CNN model; r represents a real number in [0, 1] randomly generated by a random number generator rand(0,1); \vec{d} represents a vector

$$\vec{d} = {\vec{y}}_{t - 1}^{best} - {\vec{y}}_{t - 2}^{best}$$

of a change direction of an optimal solution;

$${\vec{y}}_{t - 1}^{best} and {\vec{y}}_{t - 2}^{best}$$

correspond to optimal solutions of generations t−1 and t−2; and t represents a current iteration round.

Optionally, the generation module is specifically configured to: swap an original CNN model and a convolutional block of the original CNN model based on a first crossover operator; or swap a random bit of the original CNN model based on a second crossover operator.

others crossover operator is

$${u}_{{j}_{2}} = \{ \begin{matrix}{v}_{{j}_{2}} ; & rand ( 0 , 1 ) \leq CR , {j}_{2} = 3 {r}_{i 2} 3 {r}_{i 2} + 1 , or 3 {r}_{i 2} + 2 \\ {w}_{{j}_{2}} ; & others\end{matrix} ,$$

where, rᵢ₂=randI(0,2); rᵢ₂ represents an integer i₂ randomly generated by a random integer generator randI(0,2) within a range [0, 2]; CR represents a preset crossover probability factor; j₂ represents an index of a variable dimension j₂; uⱼ_{₂} represents a result of a first crossover operator j₂; vⱼ_{₂} represents a dimension j₂ of a mutated solution of the target mutation operator; and wⱼ_{₂} represents a dimension j₂ of an original candidate solution of the target mutation operator. The second crossover operator is

$${u}_{{j}_{3}} = \{ \begin{matrix}{v}_{{j}_{3}} ; & rand ( 0 , 1 ) \leq CR \\ {w}_{{j}_{3}} ; & others\end{matrix} ,$$

where, uⱼ_{₃} represents a result of a second crossover operator j₃; vⱼ_{₃} represents a dimension j₃ of the mutated solution of the target mutation operator; and w represents a dimension j₃ of the original candidate solution of the target mutation operator.

Optionally, the model construction module is specifically configured to evaluate the second group of CNN models based on a first objective function and a second objective function, and construct the deep ensemble model for image classification, where the first objective function is configured to determine the accuracy of the deep ensemble model, and the second objective function is configured to determine the diversity of the deep ensemble model. The first objective function is

$$a c c ( x ) = \frac{1}{N} {\sum }_{{i}_{1} = 1}^{\vert G \vert} {\sum }_{s : gx ( s ) = {i}_{1}} I ( {g}_{x} ( s ) = \hat{g} ( s ) ) ,$$

where, N represents the number of test samples, |G| represents the number of test sample types, i₁ represents the test sample i₁, x represents the solution of the test sample s, gₓ(s) represents the classification result of the solution x of the test sample s, ĝ(s) represents the real class of the test sample s, I(.) represents the discrimination function, and when gₓ(s)=ĝ(s), 1 is, returned, or otherwise, 0 is returned; and the second objective function is

$$d ( x ) = {\sum }_{{i}_{4} = 1}^{m} {\sum }_{{{j}_{4} = {i}_{4} + 1}^{}}^{m} ( \sqrt{{\sum }_{k = 1}^{d} {( {a}_{{i}_{4}}^{k} - {a}_{{j}_{4}}^{k} )}^{2}} + {\sum }_{p = 1}^{\vert G \vert} I ( g ( {a}_{{i}_{4}} , {s}_{p} ) = g ( {a}_{{j}_{4}} , {s}_{p} ) ) ) ,$$

where, aᵢ_{₄} represents an represents an output of a head i₄ of the deep ensemble model, aᵢ_{₄}^{k} represents an architecture of a k-th dimension of the head i₄, aⱼ_{₄}^{k} represents an architecture of the k-th dimension of the head j₄, g(aᵢ_{₄},sₚ) represents an output of on a p-th test sample sₚ, d represents a dimension of a code of a head,

$$\sqrt{{\sum }_{k = 1}^{d} {( {a}_{{i}_{4}}^{k} - {a}_{{j}_{4}}^{k} )}^{2}}$$

represents a Euclidean distance between the head i₄ and the head j₄, and

$${\sum }_{p = 1}^{\vert G \vert} I ( g ( {a}_{{i}_{4}} , {s}_{p} ) = g ( {a}_{{j}_{4}} , {s}_{p} ) )$$

represents a number of test samples with different classification results.

Optionally, the external archive stores non-dominated solutions meeting a preset objective function; if a first candidate solution of candidate solutions of the preset objective function meets that there are no other candidate solutions superior to the first candidate solution on two optimization objectives, namely the first objective function and the second objective function, the first candidate solution is the non-dominated solution; and the first candidate solution is any candidate solution. The preset objective function is

$$¬ ∃ {x}_{{j}_{5}} ∈ W , {j}_{5} \neq {i}_{5} , ∀ {x}_{{j}_{5}}^{k} \geq {x}_{{i}_{5}}^{k} ,$$

where, xⱼ_{₅} represents a candidate solution j₅, W represents a set of candidate solutions,

$${x}_{{i}_{5}}^{k}$$

represents the k-th dimension of a candidate solution i₅, namely xᵢ_{₅}, and

$${x}_{{f}_{5}}^{k}$$

represents the k-th dimension of the candidate solution xⱼ_{₅}, namely xⱼ_{₅}.

The external archive stores non-dominated solutions meeting a preset formula, and the solutions stored in the external archive are copies of solutions meeting requirements. The quality of the stored CNN models does not degrade due to the iterations of the population.

Optionally, the generation module is specifically configured to encode the trained first group of CNN models based on an integer array, where each element of the integer array is an index of the trained first group of CNN models, a length of the array is m, a first element of the integer array represents an index of a CNN model contributing a shared layer, and a second element to an m-th element of the integer array represent indexes of CNN models constructing a head architecture.

It needs to be noted that the apparatus for generating a neural ensemble provided by the embodiments of the present disclosure may implement various processes in the above method embodiments and can achieve the corresponding technical effects, which will not be repeated here in the embodiments of the present disclosure.

Corresponding to the foregoing method embodiments, the present disclosure further provides embodiments of the apparatus and a terminal to which the apparatus is applied.

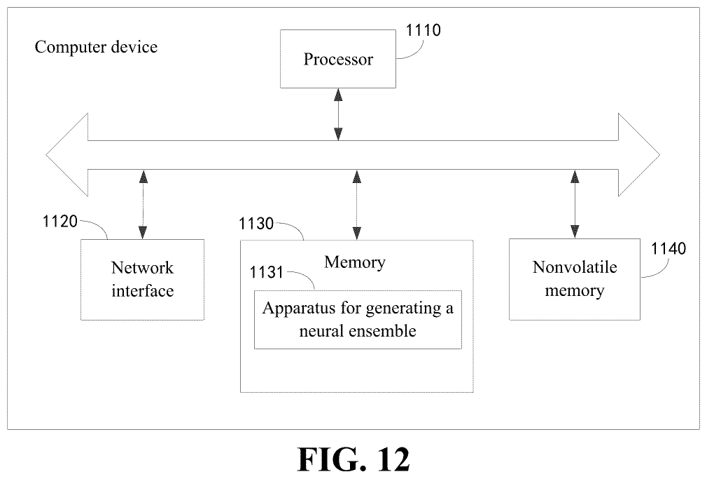

The embodiments of the apparatus for generating a deep ensemble model of the present disclosure can be applied to a computer device, e.g., a server or a terminal device. The apparatus embodiments may be implemented by software, or may be implemented by hardware or a combination of software and hardware. Taking the implementation by software as an example, an apparatus, in the logical sense, is formed by reading, by a processor for file processing where the apparatus is located, corresponding computer program instructions from a nonvolatile memory to a memory for running. In terms of hardware, as shown in FIG. 12, there is shown a hardware structure diagram of a computer device where a file processing apparatus of the embodiments of the present disclosure is located. In addition to a processor 1110, a memory 1130, a network interface 1120, and a nonvolatile memory 1140 shown in FIG. 12, a server or an electronic device where an apparatus 1131 for generating a neural ensemble in an embodiment is located may further include other hardware according to the actual functionality of the computer device, which will not be described redundantly here.

Correspondingly, the present disclosure further provides an apparatus for generating a deep ensemble model. The apparatus include a processor, and a memory configured to store processor executable instructions, where the processor is configured to: randomly sample, from a search space of classical CNN models for image classification, a neural architecture of a first group of CNN models; collect representative image samples based on a scenario of an image classification task, mark the collected image samples with classification labels, and construct a training dataset based on the marked image samples, where the image classification task includes at least one of visual search, image tagging, content filtering, medical image analysis, security surveillance, agricultural monitoring, and environmental detection; train and evaluate the sampled first group of CNN models based on the training dataset; generate a second group of CNN models based on a surrogate model and the trained first group of CNN models; and generate a structure of a deep ensemble model for image classification based on the second group of CNN model and a multi-objective optimization strategy, where the structure of the deep ensemble model includes a shared block.

The implementation processes of the functionality and actions of the modules in the aforementioned apparatus are detailed in the implementation processes of the corresponding steps in the aforesaid method, which will not be described redundantly here.

For the apparatus embodiments, since they substantially correspond to the method embodiments, it is sufficient to refer to a part of the description of the method embodiments where relevant. The apparatus embodiments described above are merely schematic, where modules described as separate components may or may not be physically separated. Components displayed as modules may or may not be physical modules, that is, the components may be located in one place, or may be distributed across a plurality of network modules. Some or all of the modules may be selected according to actual needs to implement the solutions of the present disclosure. Those of ordinary skill in the art can understand and implement the present disclosure without creative effort.

The foregoing describes the specific embodiments of the present disclosure. Other embodiments fall within the scope of the appended claims. In some cases, the actions or steps described in the claims may be performed in sequences different from those in the embodiments and still achieve expected results. In addition, the processes depicted in the accompanying drawings do not necessarily require the specific orders or sequential orders shown for achieving the expected results. In some implementations, multitasking and parallel processing are also possible or may be advantageous.

Those skilled in the art may easily conceive of other embodiments of the present disclosure after considering the specification and practicing the invention described herein. The present disclosure is intended to cover any variations, purposes or applicable changes of the present disclosure. Such variations, purposes or applicable changes follow the general principle of the present disclosure and include common knowledge or conventional technical means in the technical field which is not described in the present disclosure. The specification and embodiments are merely considered as illustrative, and the real scope and spirit of the present disclosure are pointed out by the appended claims.

It should be noted that, the present disclosure is not limited to the precise structures that have been described above and shown in the accompanying drawings, and modifications and changes can be made without departing from the scope of the present disclosure. The scope of the present disclosure is defined by the appended claims.

The foregoing are merely descriptions of the preferred embodiments of the present disclosure and are not intended to limit the present disclosure. Any modification, equivalent replacement, improvement and the like made within the spirit and principle of the present disclosure shall be included within the protection scope of the present disclosure.

What is claimed is:

1. A method for generating a deep ensemble model, comprising:
randomly sampling, from a search space of classical convolutional neural network (CNN) models for image classification, a neural architecture of a first group of CNN models;
collecting representative image samples based on a scenario of an image classification task, marking the collected image samples with classification labels, and constructing a training dataset based on the marked image samples, wherein the image classification task comprises at least one of visual search, image tagging, content filtering, medical image analysis, security surveillance, agricultural monitoring, and environmental detection;
training the sampled first group of CNN models based on the training dataset and evaluating image classification performance of the sampled first group of CNN models;
generating a second group of CNN models based on a surrogate model and the trained first group of CNN models;
randomly constructing a second parent population based on the second group of CNN models; if a stop criterion is not met, performing a bi-objective differential evolution operation on the second group of CNN models to generate a second offspring population; evaluating the second offspring population, and combining the second offspring population and the second parent population into a new second parent population; selecting, from the new second parent population, non-dominated solutions to a current multi-objective optimization problem, wherein for any non-dominated solution, no any solution that is superior to the non-dominated solution on all optimization objectives is present in the new second parent population;
updating an external archive to save the non-dominated solutions; constructing a next-generation population by tournament selection; if the stop criterion is met, decoding a solution with the highest accuracy in the external archive; and outputting a constructed CNN ensemble model, wherein the CNN ensemble model is a deep ensemble model for image classification, and a structure of the deep ensemble model comprises a shared block.

2. The method according to claim 1, wherein the generating a second group of CNN models based on a surrogate model and the trained first group of CNN models comprises:
generating the second group of CNN models based on a single-objective differential evolution operation, the surrogate model, and the trained first group of CNN models.

3. The method according to claim 2, wherein the generating the second group of CNN models based on a single-objective differential evolution operation, the surrogate model, and the trained first group of CNN models comprises:
encoding and clustering the trained first group of CNN models, extracting centroids of clustering for constructing a first parent population, and training a performance comparator using the sampled first group of CNN models;
if a training stop criterion is not met, generating a first offspring population by the single-objective differential evolution operation, and combining the first parent population and the first offspring population into a new first parent population;
determining whether the performance comparator is used;
if the performance comparator is used, sorting the new first parent population using a merging and sorting approach of the surrogate model, and constructing a next-generation population by tournament selection; and
if the training stop criterion is met, outputting a final-generation population, wherein the final-generation population is the second group of CNN models.

4. The method according to claim 3, after determining whether the performance comparator is used, the method further comprises:
if the performance comparator is not used, decoding and training the CNN models in the first offspring population;
sorting the new first parent population by accuracy; and
training the performance comparator using the first offspring population, wherein at intervals of T iterations, the CNN models of the new first parent population are trained using the training dataset, true accuracy rates of the CNN models of the new first parent population are tested using a validation dataset, candidate solutions are sorted according to the trained performance comparator, and a high-quality candidate solution is selected; incremental training is performed on the trained performance comparator using a neural architecture code of the CNN models of the new first parent population and corresponding sorted accuracy rates as training data;
or in other cases, performance of the CNN models of the new first parent population is evaluated and sorted with respect to performance using the trained performance comparator.

5. The method according to claim 3, wherein the encoding and clustering the trained first group of CNN models comprises:
encoding each CNN model in the trained first group of CNN models and an error rate of image classification corresponding to each CNN model as a real vector, and clustering the encoded real vectors into a plurality of classes,
wherein the error rate is expressed as
$$minimize f ( x ) = 1 - \frac{1}{N} {\sum }_{{i}_{1} = 1}^{\vert G \vert} {\sum }_{s : {g}_{x} ( s ) = {i}_{1}} I ( {g}_{x} ( s ) = \hat{g} ( s ) ) ,$$
where, N represents a number of test samples; |G| represents a number of test sample types; i₁ represents a test sample i₁; x represents a solution of a test sample s; gₓ(s) represents a classification result of the solution x of the test sample s; ĝ(s) represents a real class of the test sample s; I(.) represents a discrimination function; and when gₓ(s)=ĝ(s), 1 is returned, or otherwise, 0 is returned.

6. The method according to claim 1, wherein the search space of the CNN models comprises four convolutional blocks and one pooling layer; a structure of each convolutional block is determined by hyperparameters of the convolutional block that comprise at least one of a convolutional unit type, a convolutional layer channel expansion factor, and a convolutional layer repeat count; and the method further comprises:
encoding each CNN model as an integer array of a fixed length according to the hyperparameters of each convolutional block.

7. The method according to claim 2, wherein the generating the second group of CNN models based on a single-objective differential evolution operation, the surrogate model, and the trained first group of CNN models comprises:
altering each overall CNN model structure in the trained first group of CNN models based on a first mutation operator; or
altering a single convolutional block in each CNN model in the trained first group of CNN models based on a second mutation operator.

8. The method according to claim 7, wherein the first mutation operator and the second mutation operator are different values of a target mutation operator which is expressed as:
$${\vec{v}}_{t}^{{j}_{1}} = \{ \begin{matrix}{\vec{y}}^{{r}^{1}} + F \cdot ( {\vec{y}}^{{r}^{2}} - {\vec{y}}^{{r}^{3}} ) , & rang ( 0 , 1 ) \leq r \\ {\vec{y}}^{{j}_{1}} + F \cdot \vec{d} , & others\end{matrix} ,$$
where, j₁ represents an index of a CNN model j₁ in a population;
$${\vec{v}}_{t}^{j 1}$$
represents a mutation intermediate obtained after mutation of the CNN model j₁ in the population at a generation t; \vec{y}^{j}^{₁} represents the CNN model j₁ in the population; \vec{y}^{r}^{¹}, \tilde{y}^{r}^{²}, and \vec{y}^{r}^{³} represent random neighbor CNN models randomly selected from a neighborhood of \vec{y}^{j}^{₁}; F represents a factor for controlling a range of a mutated CNN model; r represents a real number in [0, 1] randomly generated by a random number generator rand(0,1); \vec{d} represents a vector
$$\vec{d} = {\vec{y}}_{t - 1}^{best} - {\vec{y}}_{t - 2}^{b e s t}$$
of a change direction of an optimal solution;
$${\vec{y}}_{t - 1}^{best} and {\vec{y}}_{t - 2}^{best}$$
correspond to optimal solutions of generations t−1 and t−2; and t represents a current iteration round.

9. The method according to claim 8, wherein the generating the second group of CNN models based on a single-objective differential evolution operation, the surrogate model, and the trained first group of CNN models comprises:
swapping an original CNN model and a convolutional block of the original CNN model based on a first crossover operator; or swapping a random bit of the original CNN model based on a second crossover operator,
wherein the first crossover operator is
$${u}_{{j}_{2}} = \{ \begin{matrix}{v}_{{j}_{2}} ; rand ( 0 , 1 ) \leq CR , {j}_{2} = 3 {r}_{i 2} , 3 {r}_{i 2} + 1 , & or 3 {r}_{i 2} + 2 \\ {w}_{{j}_{2}} ; & others\end{matrix} ,$$
where,
rᵢ₂=randI(0,2), rᵢ₂ represents an integer i₂ randomly generated by a random integer generator randI(0,2) within a range [0, 2]; CR represents a preset crossover probability factor; j₂ represents an index of a variable dimension j₂; uⱼ_{₂} represents a result of a first crossover operator j₂; vⱼ_{₂} represents a dimension j₂ of a mutated solution of the target mutation operator; and wⱼ_{₂} represents a dimension j₂ of an original candidate solution of the target mutation operator; and
the second crossover operator is
$${u}_{{j}_{3}} = \{ \begin{matrix}{v}_{j 3} ; & rand ( 0 , 1 ) \leq CR \\ {w}_{j 3} ; & others\end{matrix} ,$$
where, uⱼ_{₃} is represents a result of a second crossover operator j₃; vⱼ_{₃} represents a dimension j₃ of the mutated solution of the target mutation operator; and wⱼ_{₃} is represents a dimension j₃ of the original candidate solution of the target mutation operator.

10. The method according to claim 5, wherein constructing a structure of a deep ensemble model for image classification based on the second group of CNN models and a multi-objective optimization strategy comprises:
evaluating the second group of CNN models based on a first objective function and a second objective function, and constructing the deep ensemble model for image classification, wherein the first objective function is configured to determine the accuracy of the deep ensemble model, and the second objective function is configured to determine the diversity of the deep ensemble model;
wherein the first objective function is
$$a c c ( x ) = \frac{1}{N} {\sum }_{{i}_{1} = 1}^{\vert G \vert} {\sum }_{s : gx ( s ) = {i}_{1}} I ( {g}_{x} ( s ) = \hat{g} ( s ) ) ,$$
where, N represents the number of test samples, |G| represents the number of test sample types, i₁ represents the test sample i₁, x represents the solution of the test sample s, gₓ(s) represents the classification result of the solution x of the test sample s, ĝ(s) represents the real class of the test sample s, I(.) represents the discrimination function, and when gₓ(s)=ĝ(s), 1 is returned, or otherwise, 0 is returned; and the second objective function is
$$d ( x ) = {\sum }_{{i}_{4} = 1}^{m} {\sum }_{{{j}_{4} = {i}_{4} + 1}^{}}^{m} ( \sqrt{{\sum }_{k = 1}^{d} {( {a}_{{i}_{4}}^{k} - {a}_{{j}_{4}}^{k} )}^{2}} + {\sum }_{p = 1}^{\vert G \vert} I ( g ( {a}_{{i}_{4}} , {s}_{p} ) = g ( {a}_{{j}_{4}} , {s}_{p} ) ) ) ,$$
where, aᵢ_{₄} represents an output of a head i₄ of the deep ensemble model,
$${a}_{{i}_{4}}^{k}$$
represents an architecture of a k-th dimension of the head i₄,
$${a}_{{j}_{4}}^{k}$$
represents an architecture of the k-th dimension of the head j₄, g(aᵢ_{₄},sₚ) represents an output of aᵢ_{₄} on a p-th test sample sₚ, d represents a dimension of a code of a head,
$$\sqrt{{\sum }_{k = 1}^{d} {( {a}_{{t}_{4}}^{k} - {a}_{{j}_{4}}^{k} )}^{2}}$$
represents a Euclidean distance between the head i₄ and the head j₄, and
$${\sum }_{p = 1}^{\vert G \vert} I ( g ( {a}_{{i}_{4}} , {s}_{p} ) = g ( {a}_{{j}_{4}} , {s}_{p} ) )$$
represents a number of test samples with different classification results.

11. The method according to claim 10, wherein the external archive stores non-dominated solutions meeting a preset objective function; if a first candidate solution of candidate solutions of the preset objective function meets that there are no other candidate solutions superior to the first candidate solution on two optimization objectives, namely the first objective function and the second objective function, the first candidate solution is the non-dominated solution; and the first candidate solution is any candidate solution;
wherein the preset objective function is ¬∃xⱼ_{₅}∈W, j₅≠i₅, Λxⱼ_{₅}^{k}
$$\geq {x}_{{i}_{5}}^{k} ,$$
where, xⱼ_{₅} represents a candidate solution j₅, W represents a set of candidate solutions,
$${x}_{{i}_{5}}^{k}$$
represents the k-th dimension of a candidate solution i₅, namely xᵢ_{₅}, and
$${x}_{{j}_{5}}^{k}$$
represents the k-th dimension of the candidate solution j₅, namely xⱼ_{₅}.

12. The method according to claim 3, wherein the encoding and clustering the trained first group of CNN models comprises:
encoding the trained first group of CNN models based on an integer array,
wherein each element of the integer array is an index of the trained first group of CNN models, a length of the array is m, a first element of the integer array represents an index of a CNN model contributing a shared layer, and a second element to an m-th element of the integer array represent indexes of CNN models constructing a head architecture.

13. An apparatus for generating a deep ensemble model, comprising a sampling module, a dataset construction module, a training and evaluation module, a generation module, and a model construction module,
wherein the sampling module is configured to randomly sample, from a search space of classical convolutional neural network (CNN) models for image classification, a neural architecture of a first group of CNN models;
the dataset construction module is configured to collect representative image samples based on a scenario of an image classification task, mark the collected image samples with classification labels, and construct a training dataset based on the marked image samples, wherein the image classification task comprises at least one of visual search, image tagging, content filtering, medical image analysis, security surveillance, agricultural monitoring, and environmental detection;
the training and evaluation module is configured to train the sampled first group of CNN models based on the training dataset and evaluate image classification performance of the sampled first group of CNN models;
the generation module is configured to generate a second group of CNN models based on a surrogate model and the trained first group of CNN models; and
the model construction module is configured to: randomly construct a second parent population based on the second group of CNN models; if a stop criterion is not met, perform a bi-objective differential evolution operation on the second group of CNN models to generate a second offspring population; evaluate the second offspring population, and combine the second offspring population and the second parent population into a new second parent population; select, from the new second parent population, non-dominated solutions to a current multi-objective optimization problem, wherein for any non-dominated solution, no any solution that is superior to the non-dominated solution on all optimization objectives is present in the new second parent population; update an external archive to save the non-dominated solutions;
construct a next-generation population by tournament selection; if the stop criterion is met, decode a solution with the highest accuracy in the external archive; and output a constructed CNN ensemble model, wherein the CNN ensemble model is a deep ensemble model for image classification, and a structure of the deep ensemble model comprises a shared block.

14. A computer device, comprising a memory, a processor, and a computer program stored on the memory and runnable on the processor, wherein the processor, when executing the program, implements the method according to claim 1.
